(19) United States
(12) Patent Application Publication
(10) Pub. No.: US 2025/0374203 A1
(43) Pub. Date: Dec. 4, 2025

(54) UPLINK POWER CONTROL FOR L1/L2 BASED CELL CHANGE

(71) Applicant: QUALCOMM Incorporated, San Diego, CA (US)

(72) Inventors: Fang YUAN, Beijing (CN); Wooseok NAM, San Diego, CA (US); Yan ZHOU, San Diego, CA (US); Tao LUO, San Diego, CA (US)

(21) Appl. No.: 18/874,546

(22) PCT Filed: Aug. 12, 2022
(86) PCT No.: PCT/CN2022/112088

§ 371 Date: Dec. 12, 2024

(51) Int. Cl. H04W 52/24; H04W 8/22; H04W 16/28; H04W 52/14

(52) U.S. Cl. CPC H04W 52/242; H04W 8/22; H04W 16/28; H04W 52/146

(57) ABSTRACT

Example implementations include a method, apparatus and computer-readable medium of wireless communication by a user equipment, comprising receiving an indication of a first set of PLRSs in a first cell or an indication of a second set of PLRSs in a second cell, prior to a cell activation indication being received in the second cell, wherein the first cell is a deactivated cell and the second cell is an active cell. The implementations further includes receiving the cell activation indication in the second cell activating the first cell. Additionally, the implementations further includes transmitting an uplink signal in the first cell based on a first transmission power measurement or a second transmission power measurement, in response to receiving the cell activation indication, where the first transmission power measurement is based on the first set of PLRSs and the second transmission power measurement is based on the second set of PLRSs.

### BACKGROUND

### Technical Field

The present disclosure generally relates to communication systems, and more particularly, to uplink power control for L1/L2 based cell change.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard.

There exists a need for further improvements in 5G NR technology. These improvements may also be applicable to other multi-access technologies and the telecommunication standards that employ these technologies. For instance, improvements to efficiency and latency relating to mobility of user equipments (UEs) communicating with network entities are desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Certain aspects are directed to a method for wireless communication at a user equipment. In some examples, the method includes receiving an indication of a first set of path loss reference signals (PLRSs) in a first cell or an indication of a second set of PLRSs in a second cell, prior to a cell activation indication being received in the second cell, wherein the first cell is a deactivated cell and the second cell is an active cell. In some examples, the method further includes receiving the cell activation indication in the second cell activating the first cell. Additionally, in some examples, the method further includes transmitting an uplink signal in the first cell based on a first transmission power measurement or a second transmission power measurement, in response to receiving the cell activation indication, where the first transmission power measurement is based on the first set of PLRSs and the second transmission power measurement is based on the second set of PLRSs.

Certain aspects are directed to a method for wireless communication at a network entity. In some examples, the method includes transmitting an indication of a first set of path loss reference signals (PLRSs) in a first cell or an indication of a second set of PLRSs in a second cell, prior to a cell activation indication being transmitted in the second cell, where the first cell is a deactivated cell and the second cell is an active cell. In some examples, the method further includes transmitting the cell activation indication in the second cell activating the first cell. Additionally, in some examples, the method further includes receiving an uplink signal in the first cell in response to transmitting the cell activation indication.

Certain aspects are directed to an apparatus configured for wireless communication, comprising a processor, a memory coupled with the processor, and instructions stored in the memory, when executed by the processor, cause the apparatus to receive an indication of a first set of path loss reference signals (PLRSs) in a first cell or an indication of a second set of PLRSs in a second cell, prior to a cell activation indication being received in the second cell, wherein the first cell is a deactivated cell and the second cell is an active cell. In some examples, the instructions, when executed by the processor, further cause the apparatus to receive the cell activation indication in the second cell activating the first cell. In some examples, the instructions, when executed by the processor, further cause the apparatus to transmit an uplink transmission signal in the first cell based on a first transmission power measurement or a second transmission power measurement, in response to receiving the cell activation indication, wherein the first transmission power measurement is based on the first set of PLRSs and the second transmission power measurement is based on the second set of PLRSs.

Certain aspects are directed to an apparatus configured for wireless communication, comprising a processor, a memory coupled with the processor, and instructions stored in the memory, when executed by the processor, cause the apparatus to transmit an indication of a first set of path loss reference signals (PLRSs) in a first cell or an indication of a second set of PLRSs in a second cell, prior to a cell activation indication being transmitted in the second cell, wherein the first cell is a deactivated cell and the second cell is an active cell. In some examples, the instructions, when executed by the processor, further cause the apparatus to transmit the cell activation indication in the second cell activating the first cell. In some examples, the instructions, when executed by the processor, further cause the apparatus to receive an uplink transmission signal in the first cell based on a first transmission power measurement or a second transmission power measurement, and based on the in response to transmitting transmission of the cell activation indication.

Certain aspects are directed to a non-transitory computer-readable medium having instructions stored thereon that, when executed by an apparatus, cause the apparatus to perform operations comprising receiving an indication of a first set of path loss reference signals (PLRSs) in a first cell or an indication of a second set of PLRSs in a second cell, prior to a cell activation indication being received in the second cell, wherein the first cell is a deactivated cell and the second cell is an active cell. In some examples, the operations include receiving the cell activation indication in the second cell activating the first cell. In some examples, the operations include transmitting an uplink signal in the first cell based on a first transmission power measurement or a second transmission power measurement, in response to receiving the cell activation indication, where the first transmission power measurement is based on the first set of PLRSs and the second transmission power measurement is based on the second set of PLRSs.

Certain aspects are directed to a non-transitory computer-readable medium having instructions stored thereon that, when executed by an apparatus, cause the apparatus to perform operations comprising transmitting an indication of a first set of path loss reference signals (PLRSs) in a first cell or an indication of a second set of PLRSs in a second cell, prior to a cell activation indication being transmitted in the second cell, where the first cell is a deactivated cell and the second cell is an active cell. In some examples, the operations include includes transmitting the cell activation indication in the second cell activating the first cell. Additionally, in some examples, the method further includes receiving an uplink signal in the first cell in response to transmitting the cell activation indication.

Certain aspects are directed to an apparatus for wireless communication. In some examples, the apparatus includes means for receiving an indication of a first set of path loss reference signals (PLRSs) in a first cell or an indication of a second set of PLRSs in a second cell, prior to a cell activation indication being received in the second cell, wherein the first cell is a deactivated cell and the second cell is an active cell. In some examples, the apparatus includes means for receiving the cell activation indication in the second cell activating the first cell. In some examples, the apparatus includes means for transmitting an uplink signal in the first cell based on a first transmission power measurement or a second transmission power measurement, in response to receiving the cell activation indication, where the first transmission power measurement is based on the first set of PLRSs and the second transmission power measurement is based on the second set of PLRSs.

Certain aspects are directed to an apparatus for wireless communication. In some examples, the apparatus includes means for transmitting an indication of a first set of path loss reference signals (PLRSs) in a first cell or an indication of a second set of PLRSs in a second cell, prior to a cell activation indication being transmitted in the second cell, where the first cell is a deactivated cell and the second cell is an active cell. In some examples, the apparatus includes means for transmitting the cell activation indication in the second cell activating the first cell. In some examples, the apparatus includes means for receiving an uplink signal in the first cell in response to transmitting the cell activation indication

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1A is a diagram illustrating an example of a wireless communications system and an access network.

FIG. 1B is a diagram illustrating an example of disaggregated base station architecture, in accordance with various aspects of the present disclosure.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4A is a diagram illustrating an example of a configured cell set for carrier aggregation.

FIG. 4B is a diagram illustrating an example of a configured cell set without carrier aggregation or dual connectivity.

FIG. 5A is a diagram illustrating an example of a call flow between a network entity and a UE, in accordance with various aspects of present disclosure.

FIG. 5B is a diagram illustrating an example of a call flow between a network entity and a UE, in accordance with various aspects of present disclosure.

FIG. 5C is a diagram illustrating an example of a call flow between a network entity and a UE, in accordance with various aspects of present disclosure.

FIG. 5D is a diagram illustrating an example of a call flow between a network entity and a UE, in accordance with various aspects of present disclosure.

FIG. 5E is a diagram illustrating an example of a call flow between a network entity and a UE, in accordance with various aspects of present disclosure.

FIG. 6 is a diagram illustrating an example of a hardware implementation for an example apparatus.

FIG. 7 is a flowchart of a method of wireless communication.

FIG. 8 is a flowchart of a method of wireless communication.

FIG. 9 is a flowchart of a method of wireless communication.

FIG. 10 is a flowchart of a method of wireless communication.

FIG. 11 is a flowchart of a method of wireless communication.

FIG. 12 is a flowchart of a method of wireless communication.

FIG. 13 is a flowchart of a method of wireless communication.

FIG. 14 is a flowchart of a method of wireless communication.

FIG. 15 is a diagram illustrating another example of a hardware implementation for another example apparatus.

FIG. 16 is a flowchart of a method of wireless communication.

FIG. 17 is a flowchart of a method of wireless communication.

FIG. 18 is a flowchart of a method of wireless communication.

FIG. 19 is a flowchart of a method of wireless communication.

FIG. 20 is a flowchart of a method of wireless communication.

FIG. 21 is a flowchart of a method of wireless communication.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Some techniques for activating a deactivated cell to a newly activated cell and transmitting an uplink transmission in the newly activated cell may be too slow and time consuming. For example, some techniques for a UE to activate a currently deactivated cell to a newly activated cell and transmit an uplink transmission in the newly activated cell generally require the UE to determine transmission power requirements in the newly activated cell based on a path loss reference signal (PLRS) received after a cell activation command, and then transmit an uplink transmission based on the determined transmission power. However, operations to determine transmission power requirements in the newly activated cell can be time consuming, which can cause the UE to fail latency requirements and/or any other quality of service (QoS) requirements.

The techniques described herein provide a manner in which a UE may transmit uplink transmissions in a cell that is newly activated from a deactivated cell. In an aspect, UE may be configured to receive one or more reference signals (e.g., a PLRS) in the cell while the cell is still a deactivated cell and prior to receiving a cell activation command activating that cell. In an aspect, in response to receiving a cell activation command activating that cell from a deactivated cell to an active cell, the UE may be configured to transmit an uplink transmission based on transmission power measurements that are based on PLRSs received prior to the cell activation command. Accordingly, because the UE transmits the uplink transmission based on PLRSs received prior to receiving the cell activation command, the UE may transmit the uplink link transmission earlier (e.g., with reduced latency) than if the UE were to transmit the uplink transmission based on measurements of PLRSs received after the activation command.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

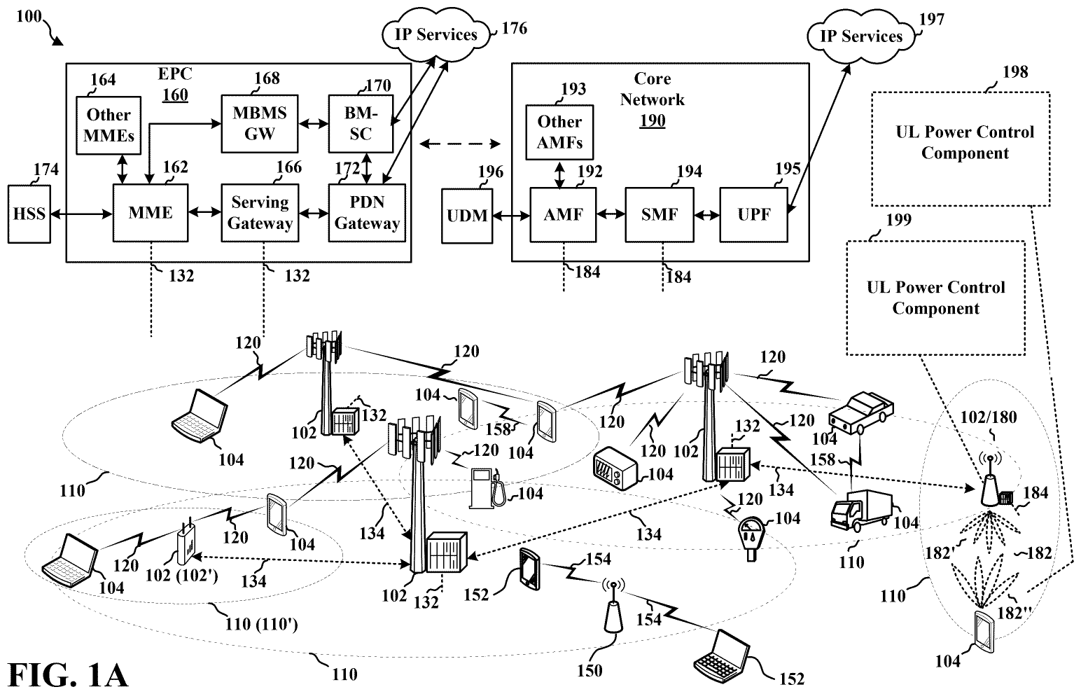

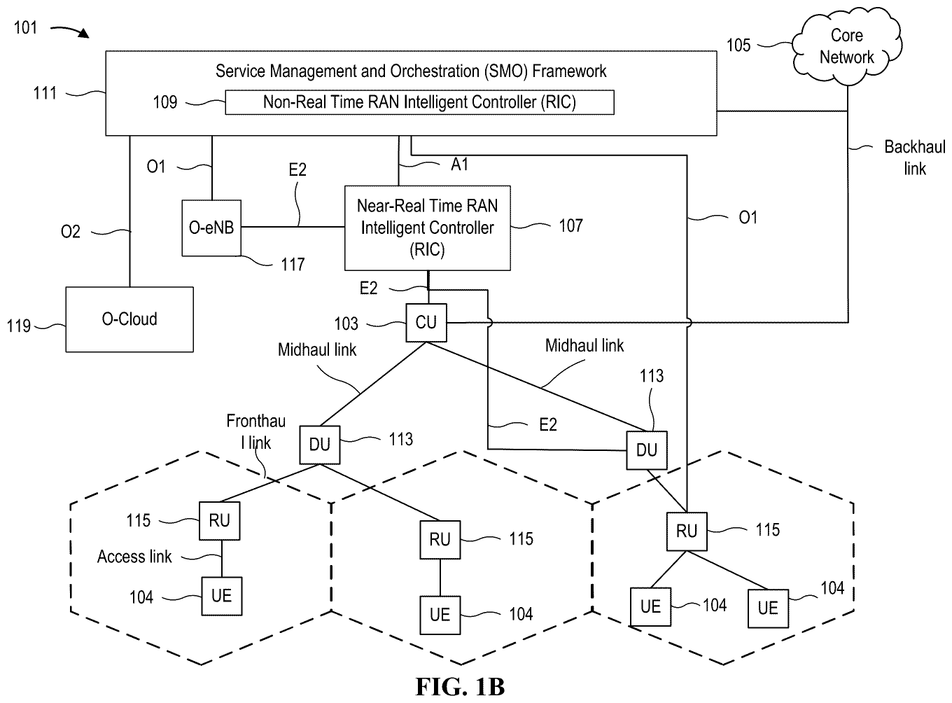

FIG. 1A is a diagram illustrating an example of a wireless communications system 100 (also referred to as a wireless wide area network (WWAN)) that includes base stations 102 (also referred to herein as network entities), user equipment(s) (UE) 104, an Evolved Packet Core (EPC) 160, and another core network 190 (e.g., a 5G Core (5GC)).

One or more of the UE 104 may include an uplink (UL) power control component 198, and one or more of the base stations 102/180 may be configured to include an UL power control component 199, wherein the UL power control component 198 and the UL power control component 199 are operable to perform power measurement and/or control techniques for reducing latency for UE 104 in activating a deactivated cell to a newly activated cell and transmitting uplink signals in the newly activated cell.

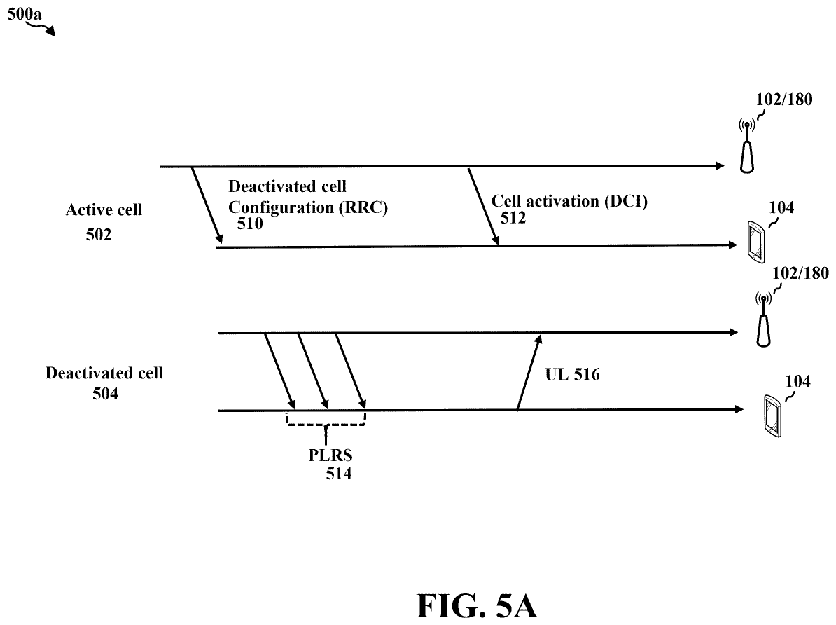

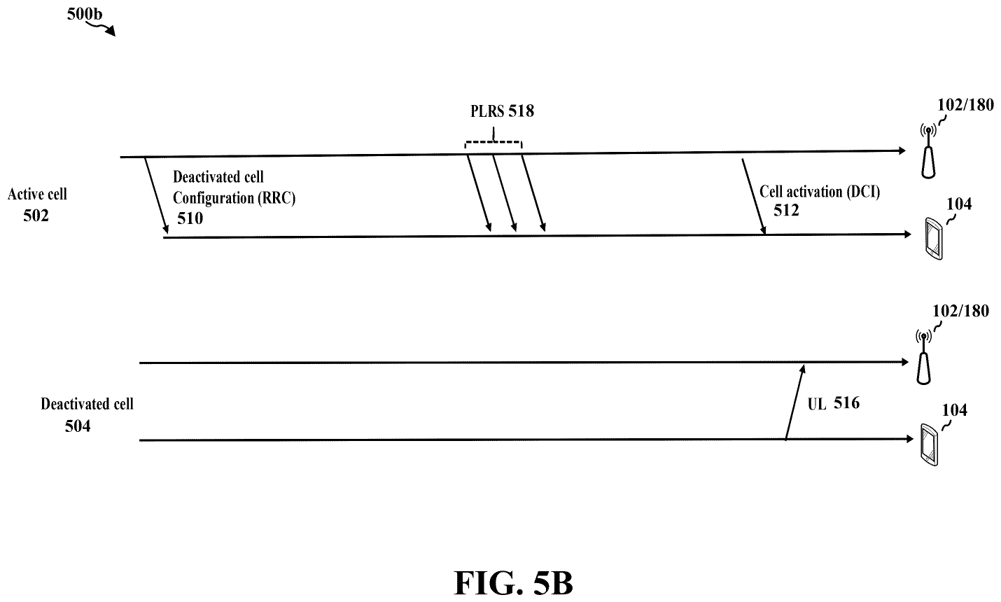

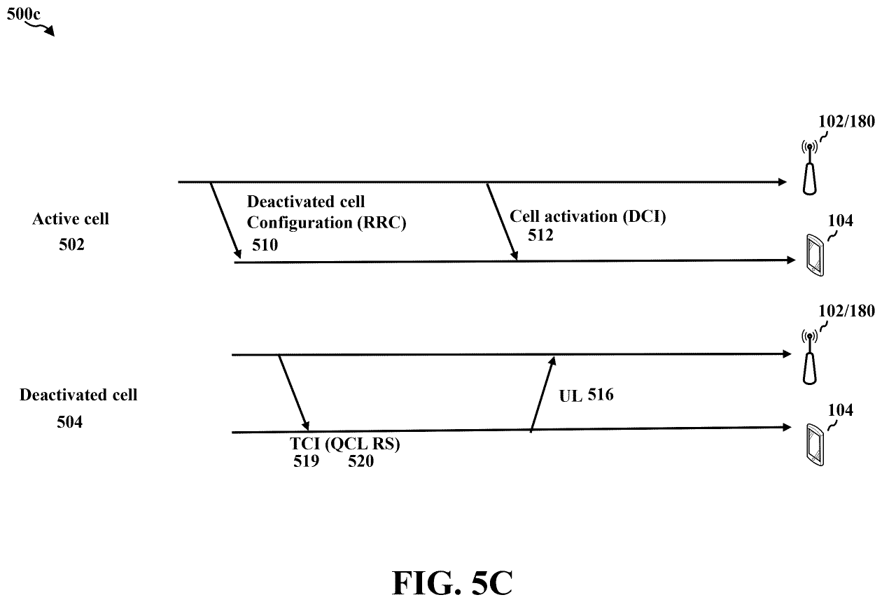

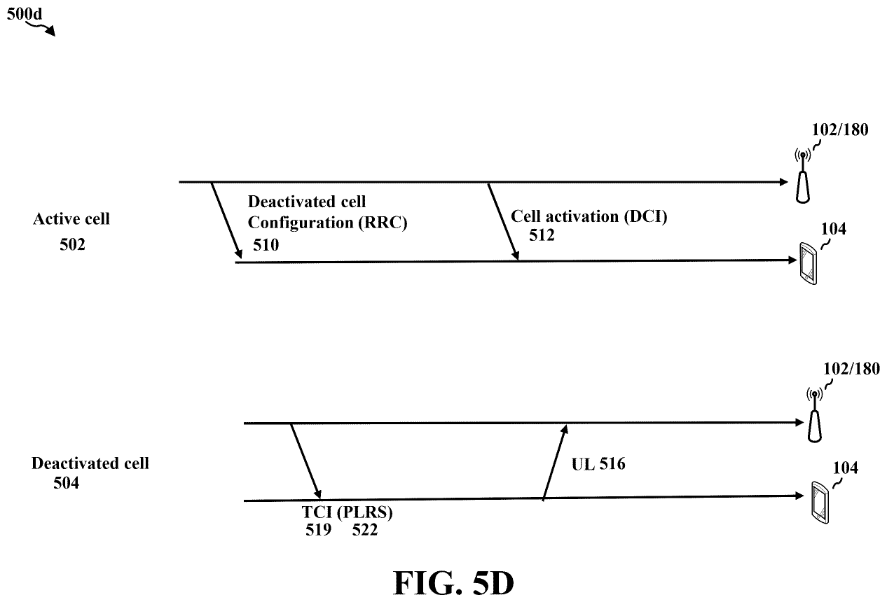

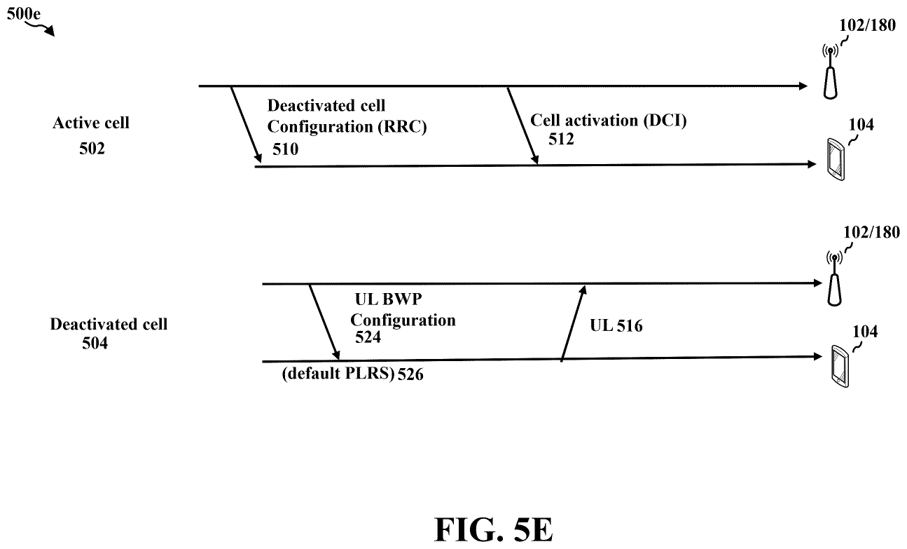

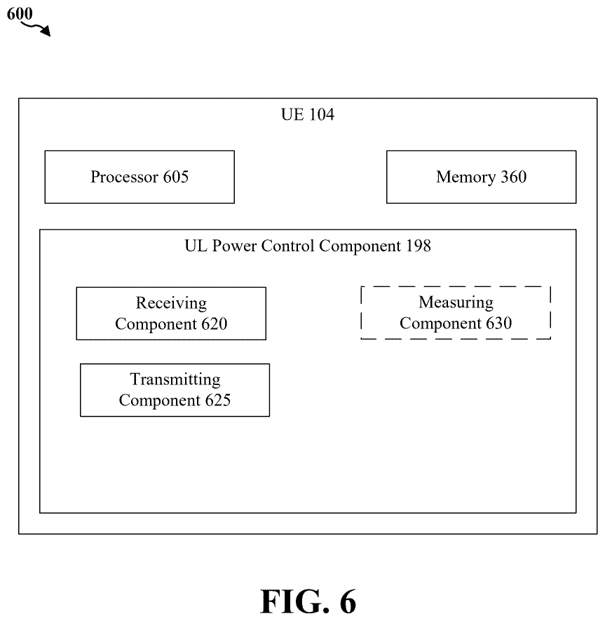

At one or more of the UEs 104, and additionally referring to FIG. 6, the UL power control component 198 includes a receiving component 620 configured to receive an indication of a first set of path loss reference signals (PLRSs) in a first cell or an indication of a second set of PLRSs in a second cell, prior to a cell activation indication being received in the second cell, wherein the first cell is a deactivated cell and the second cell is an active cell. Further, the receiving component 620 of the UL power control component 198 is further configured to receive the cell activation indication in the second cell activating the first cell. Additionally, the UL power control component 198 includes a transmitting component 625 configured to transmit an uplink signal in the first cell based on a first transmission power measurement or a second transmission power measurement, in response to receiving the cell activation indication, wherein the first transmission power measurement is based on the first set of PLRSs and the second transmission power measurement is based on the second set of PLRSs. Also, in some optional or additional aspects, the UL power control component 198 includes measuring component 630 configured to measure one or more channel metrics of PLRSs in the first cell prior to the cell activation being received in the second cell or measure one or more channel metrics of PLRSs in the second cell prior to the cell activation being received in the second cell. Additional details of the UL power control component 198 and/or any of the foregoing components are provided below, for example, with reference to FIGS. 5A-21.

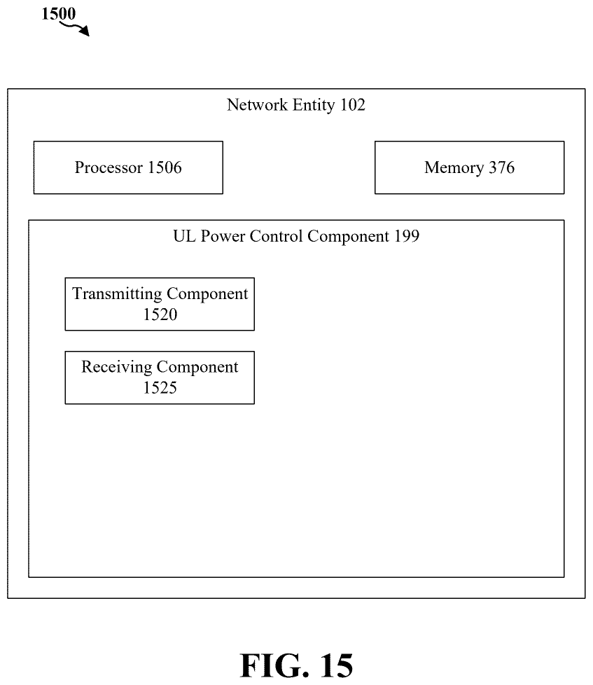

At one or more of the base stations 102/180 (or, network entities), and additionally referring to FIG. 15, the UL power control component 199 includes a transmitting component 1520 configured to transmit an indication of a first set of path loss reference signals (PLRSs) in a first cell or an indication of a second set of PLRSs in a second cell, prior to a cell activation indication being transmitted in the second cell, wherein the first cell is a deactivated cell and the second cell is an active cell. Further, the transmitting component 1520 of UL power control component 199 is further configured to transmit the cell activation indication in the second cell activating the first cell. Additionally, the UL power control component 199 includes a receiving component 1525 configured to receive an uplink transmission in the first cell in response to the transmission of the cell activation indication. Additional details of the UL power control component 199 and/or any of the foregoing components are provided below, for example, with reference to FIGS. 5A-21

The base stations (or network entities) 102 may include macrocells (high power cellular base station) and/or small cells (low power cellular base station). The macrocells include base stations. The small cells include femtocells, picocells, and microcells. The base stations 102 can be configured in a Disaggregated RAN (D-RAN) or Open RAN (O-RAN) architecture, where functionality is split between multiple units such as a central unit (CU), one or more distributed units (DUs), or a radio unit (RU). Such architectures may be configured to utilize a protocol stack that is logically split between one or more units (such as one or more CUs and one or more DUs). In some aspects, the CUs may be implemented within an edge RAN node, and in some aspects, one or more DUs may be co-located with a CU, or may be geographically distributed throughout one or multiple RAN nodes. The DUs may be implemented to communicate with one or more RUs. Any of the disaggregated components in the D-RAN and/or O-RAN architectures may be referred to herein as a network entity.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell). Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). The frequencies between FR1 and FR2 are often referred to as mid-band frequencies. Although a portion of FR1 is greater than 6 GHZ, FR1 is often referred to (interchangeably) as a “sub-6 GHZ” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a network entity, gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, monitors, cameras, industrial/manufacturing devices, appliances, vehicles, robots, drones, etc.). IoT UEs may include machine type communications (MTC)/enhanced MTC (eMTC, also referred to as category (CAT)-M, Cat M1) UEs, NB-IoT (also referred to as CAT NB1) UEs, as well as other types of UEs. In the present disclosure, eMTC and NB-IoT may refer to future technologies that may evolve from or may be based on these technologies. For example, eMTC may include FeMTC (further eMTC), eFeMTC (enhanced further eMTC), mMTC (massive MTC), etc., and NB-IoT may include eNB-IoT (enhanced NB-IoT), FeNB-IoT (further enhanced NB-IoT), etc. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

FIG. 1B is a diagram illustrating an example of disaggregated base station 101 architecture, any component or element of which may be referred to herein as a network entity. The disaggregated base station 101 architecture may include one or more central units (CUs) 103 that can communicate directly with a core network 105 via a backhaul link, or indirectly with the core network 105 through one or more disaggregated base station units (such as a Near-Real Time (Near-RT) RAN Intelligent Controller (RIC) 107 via an E2 link, or a Non-Real Time (Non-RT) RIC 109 associated with a Service Management and Orchestration (SMO) Framework 111, or both). A CU 103 may communicate with one or more distributed units (DUs) 113 via respective midhaul links, such as an F1 interface. The DUs 113 may communicate with one or more radio units (RUs) 115 via respective fronthaul links. The RUs 115 may communicate with respective UEs 104 via one or more radio frequency (RF) access links. In some implementations, the UE 104 may be simultaneously served by multiple RUs 115.

Each of the units, e.g., the CUs 103, the DUs 113, the RUs 115, as well as the Near-RT RICs 107, the Non-RT RICs 109 and the SMO Framework 111, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 103 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 103. The CU 103 may be configured to handle user plane functionality (i.e., Central Unit-User Plane (CU-UP)), control plane functionality (i.e., Central Unit-Control Plane (CU-CP)), or a combination thereof. In some implementations, the CU 103 can be logically split into one or more CU-UP units and one or more CU-CP units. The CU-UP unit can communicate bidirectionally with the CU-CP unit via an interface, such as the E1 interface when implemented in an O-RAN configuration. The CU 103 can be implemented to communicate with the DU 113, as necessary, for network control and signaling.

The DU 113 may correspond to a logical unit that includes one or more base station functions to control the operation of one or more RUs 115. In some aspects, the DU 113 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the third Generation Partnership Project (3GPP). In some aspects, the DU 113 may further host one or more low PHY layers. Each layer (or module) can be implemented with an interface configured to communicate signals with other layers (and modules) hosted by the DU 113, or with the control functions hosted by the CU 103.

Lower-layer functionality can be implemented by one or more RUs 115. In some deployments, an RU 115, controlled by a DU 113, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 115 can be implemented to handle over the air (OTA) communication with one or more UEs 104. In some implementations, real-time and non-real-time aspects of control and user plane communication with the RU(s) 115 can be controlled by the corresponding DU 113. In some scenarios, this configuration can enable the DU(s) 113 and the CU 103 to be implemented in a cloud-based RAN architecture, such as a vRAN architecture.

The SMO Framework 111 may be configured to support RAN deployment and provisioning of non-virtualized and virtualized network elements. For non-virtualized network elements, the SMO Framework 111 may be configured to support the deployment of dedicated physical resources for RAN coverage requirements which may be managed via an operations and maintenance interface (such as an O1 interface). For virtualized network elements, the SMO Framework 111 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 103, DUs 113, RUs 115 and Near-RT RICs 107. In some implementations, the SMO Framework 111 can communicate with a hardware aspect of a 4G RAN, such as an open eNB (O-eNB) 117, via an O1 interface. Additionally, in some implementations, the SMO Framework 111 can communicate directly with one or more RUs 115 via an O1 interface. The SMO Framework 111 also may include a Non-RT RIC 109 configured to support functionality of the SMO Framework 111.

The Non-RT RIC 109 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 107. The Non-RT RIC 109 may be coupled to or communicate with (such as via an A1 interface) the Near-RT RIC 107. The Near-RT RIC 107 may be configured to include a logical function that enables near-real-time control and optimization of RAN elements and resources via data collection and actions over an interface (such as via an E2 interface) connecting one or more CUs 103, one or more DUs 113, or both, as well as an O-eNB, with the Near-RT RIC 107.

In some implementations, to generate AI/ML models to be deployed in the Near-RT RIC 107, the Non-RT RIC 109 may receive parameters or external enrichment information from external servers. Such information may be utilized by the Near-RT RIC 107 and may be received at the SMO Framework 111 or the Non-RT RIC 109 from non-network data sources or from network functions. In some examples, the Non-RT RIC 109 or the Near-RT RIC 107 may be configured to tune RAN behavior or performance. For example, the Non-RT RIC 109 may monitor long-term trends and patterns for performance and employ AI/ML models to perform corrective actions through the SMO Framework 111 (such as reconfiguration via O1) or via creation of RAN management policies (such as A1 policies).

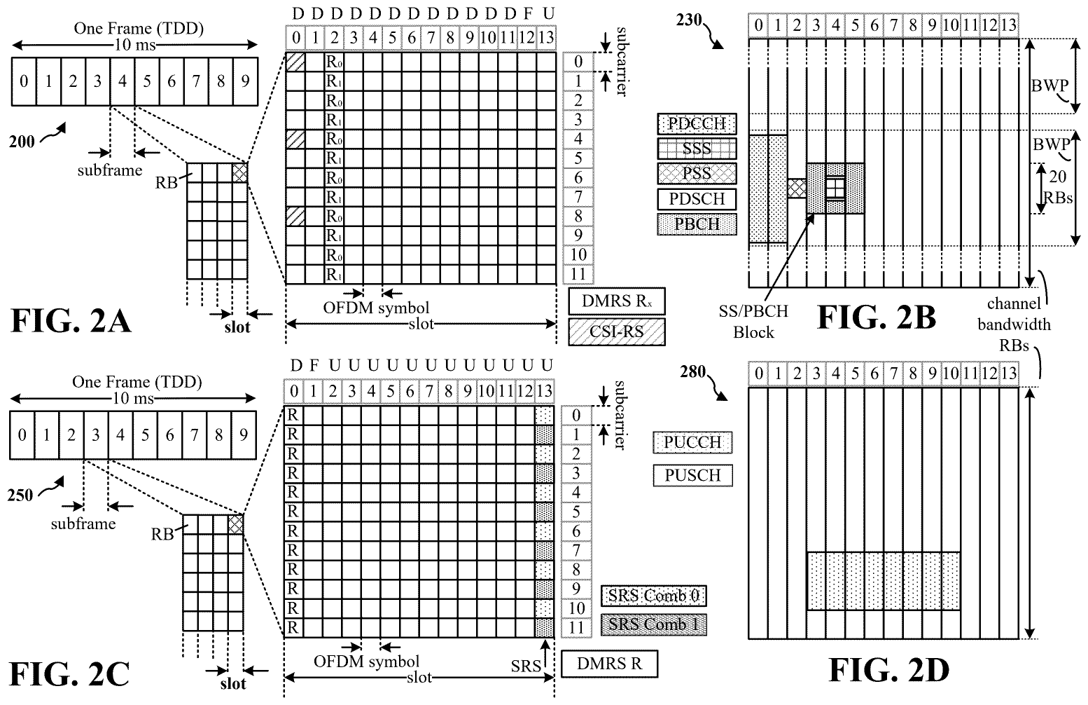

FIGS. 2A-2D are diagrams of various frame structures, resources, and channels used by UEs 104 and base stations 102/180 for communication. FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 24 slots/subframe. The subcarrier spacing and symbol length/duration are a function of the numerology. The subcarrier spacing may be equal to 2^{μ}*15 kilohertz (kHz), where μ is the numerology 0 to 4. As such, the numerology u=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

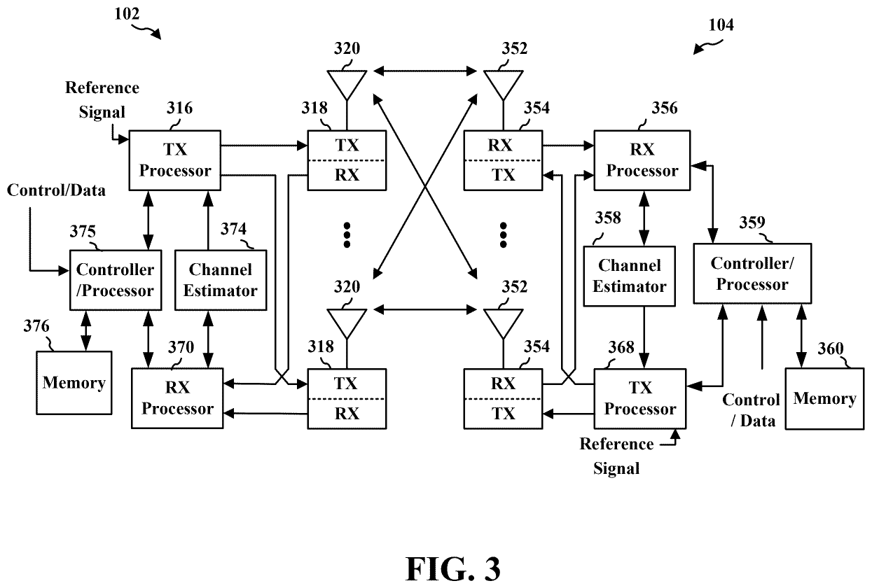

FIG. 3 is a block diagram of hardware components of the base station 102 (or 180) in communication with the UE 104 in the wireless communication network 100. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 104. Each spatial stream may then be provided to a different antenna 320 via a separate transmitter 318TX. Each transmitter 318TX may modulate an RF carrier with a respective spatial stream for transmission.

At the UE 104, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 104. If multiple spatial streams are destined for the UE 104, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 102. These soft decisions may be based on channel estimates computed by the channel estimator 358. The soft decisions are then decoded and deinterleaved to recover the data and control signals that were originally transmitted by the base station 102 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 102, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 102 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 102 in a manner similar to that described in connection with the receiver function at the UE 104. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 104. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with UL power control component 198 of FIG. 1A. For example, the memory 360 may include executable instructions defining the UL power control component 198. The TX processor 368, the RX processor 356, and/or the controller/processor 359 may be configured to execute the UL power control component 198.

At least one of the TX processor 316, the RX processor 370, and the controller/processor 375 may be configured to perform aspects in connection with UL power control component 199 of FIG. 1A. For example, the memory 376 may include executable instructions defining the UL power control component 199. The TX processor 316, the RX processor 370, and/or the controller/processor 375 may be configured to execute the UL power control component 199.

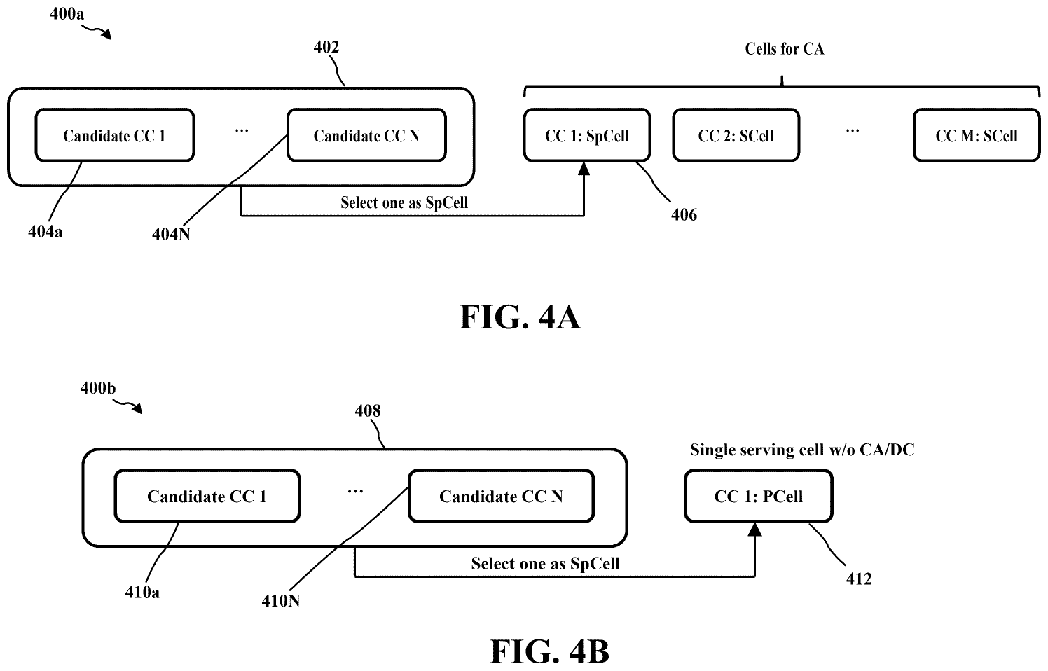

Referring to example 400a of FIG. 4A, a UE 104 may be configured to perform a layer 1 (L1)/layer (L2) based cell switching for cell change during mobility. In a L1/L2 based cell activation, the UE 104 may receive a cell switching command via a L1/L2 message (e.g., a MAC-CE, a DCI, or the like). As described herein, a L1/L2 based cell switching, will be referred to as “fast cell switching.” The UE 104 may receive a configuration indicating a set of candidate cells 402 from a network entity (e.g., network entity 102/180). The set of candidate cells 402, as shown in FIG. 4A, may include one or more candidate cells, 404a . . . 404N. The set of candidate cells may be configured to be selected as a special cell (SpCell). In some implementations, an SpCell may be a primary cell (PCell), a primary/secondary cell (PSCell), and/or a combination of them. For example, the UE 104 may receive a CellGroupConfig configuration via an RRC message indicating the set of candidate cells 404a . . . 404N. In some aspects, the cell switching command may be a cell activation command indicating the activation of at least one candidate cell.

The UE 104 may receive a cell activation indication (e.g., a cell activation command) indicating one of the candidate cells 404a . . . 404N in a currently active cell 406, and in response to the cell activation indication, the UE 104 may be configured to select the indicated candidate cell as the new SpCell. For example, the UE 104 may receive a cell activation indication indicating candidate cell 404a to be activated, and the UE 104 may select candidate cell 404a as the new SpCell. Referring to example 400b of FIG. 4B, in some implementations, the UE may only be configured with a single serving cell without carrier aggregation or dual connectivity. The UE 104 may receive a configuration indicating a set of candidate cells 408 from a network entity (e.g., network entity 102/180). The set of candidate cells 408, as shown in FIG. 4A, may include one or more candidate cells, 410a . . . 410N. The UE 104 may receive a cell activation indication (e.g., a cell activation command) indicating one of the candidate cells 410a . . . 410N in a currently active cell 412. The UE 104 may select the candidate cell indicated in the cell activation command as the new PCell.

To reduce the latency for the UE to transmit an uplink signal in the new active cell (e.g., the new SpCell or the new PCell), the UE may be configured to determine power transmission measurements for uplink transmissions prior to receiving the cell activation indication in a current active cell (e.g., a SpCell or PCell) and/or determine power transmission measurements for uplink transmission based on reference signals (e.g., PLRSs) received prior to receiving the cell activation indication in the current active cell. Additional details of determining power transmission measurements for uplink transmissions prior to receiving the cell activation indication and/or determining power transmission measurements for uplink transmission based on reference signals (e.g., PLRSs) received prior to receiving the cell activation indication in the current active cell are described herein with reference to FIGS. 5A-21.

Referring to example 500a of FIG. 5A, cell 502 is the current active cell and may be a current serving cell of UE 104. The UE 104 may receive a candidate cell configuration and/or a deactivated cell configuration 510 (e.g., in a CellGroupConfig) in the active cell 502, as shown in FIG. 5A. As described above, with reference to FIGS. 4A and/or 4B, the deactivated cell 504 may be one of the candidate cells indicated in the candidate cell configuration. In some implementations, the configuration 510 may include a configuration for one or more path loss reference signals (PLRS) (e.g., SSB, CSI-RS, or the like) for each of the deactivated candidate cells indicated in the configuration 510.

The UE 104 may be configured to monitor for one or more PLRS in each of the deactivated candidate cells indicated in the configuration 510 prior to receiving a cell activation indication 512 in the current active cell 502. For example, the UE 104 may be configured to monitor for the set of PLRS 514 in the deactivated cell 504 prior to receiving the cell activation indication 512. The UE 104 may receive one or more configured PLRS from the network entity 102 prior to receiving the cell activation indication 512.

The UE 104 may be configured to measure one or more channel metrics (e.g., RSRP, SNR, SINR, or the like) for the set of PLRS received in one or more configured deactivated cells prior to receiving the cell activation indication in the active cell 502. For example, in the deactivated cell 504, the UE 104 may be configured to measure the one or more channel metrics for one or more PLRS in the set of PLRS 514 received in the deactivated cell 504 prior to receiving the cell activation indication in the active cell 502. In some implementations, the UE 104 may be configured to measure channel metrics for each PLRS received in each deactivated cell prior to receiving the cell activation indication 512 in the active cell 502.

The UE 104 may be configured to determine a transmission power measurement for transmitting an uplink signal (e.g., an uplink signal via PUCCH, uplink signal via PUSCH, or the like) in a currently deactivated candidate cell prior to receiving the cell activation indication 512 in the active cell 502. For example, the UE 104 may be configured to determine a transmission power measurement for transmitting an uplink signal 516 in the currently deactivated candidate cell 504 prior to receiving the cell activation indication 512 in the active cell 502. In some implementations, the UE 104 may be configured to determine the transmission power measurement for uplink transmissions in each of the deactivated candidate cells indicated in the configuration 510. In some implementations, the transmission power measurement for transmitting the uplink signal in the currently deactivated candidate cell may be determined simultaneously with or after receiving the cell activation indication 512. In such a case, the power measurement would still be based on the set of PLRS 514 received prior to the cell activation indication 512.

The UE 104 may be configured to determine the transmission power measurement based on a power control algorithm, a power setting algorithm, and/or the like, and the one or more measured channel metrics of the one or more PLRS received prior to receiving cell activation indication 512 in the active cell 502.

The UE 104 may be configured to send an uplink transmission based on the determined transmission power measurement in response to receiving the cell activation indication 512. In some implementations, the UE 104 may be configured to send the uplink transmission immediately after receiving the cell activation indication 512 in an active cell of the UE 104. For example, the UE 104 may be configured to send an uplink transmission in the very next slot after the slot in which it receives a cell activation indication in the active cell 502.

Referring to example 500b of FIG. 5B, in some implementations, one or more of the deactivated candidate cells may not be configured with a set of PLRS. The UE 104 may be configured to determine a transmission power measurement for transmitting an uplink transmission in these deactivated candidate cells based on measurement of channel metrics of one or more PLRS received in the active cell. For example, if deactivated candidate cell 504 is not configured with a set of PLRS (e.g., PLRS 514), the UE 104 may determine a transmission power measurement for the UL signal 516 based on channel metric measurement(s) of one or more PLRSs 518 received in the active cell 502. The UE 104 may be configured to determine the transmission power measurement prior to receiving the cell activation indication 512. In some implementations, the transmission power measurement for transmitting the uplink signal in the currently deactivated candidate cell may be determined simultaneously with or after receiving the cell activation indication 512. In such a case, the power measurement would still be based on the set of PLRS 518 received prior to the cell activation indication 512

Referring to example 500c of FIG. 5C, in some implementations, the configuration 510 may include configuration(s) for one or more transmission configuration indicator (TCI) states for one or more of the deactivated cells indicated in the configuration 510. The one or more TCI state configurations may indicate a quasi co-located reference signal (QCL RS) for the TCI state. The UE 104 may be configured to monitor for and/or receive a TCI state (e.g., an activated TCI state) in the configured deactivated cells prior to receiving the cell activation indication 512 in the active cell 502. For example, as shown in FIG. 5C, the UE 104 may receive TCI state 519 from the network entity 102/180 in the deactivated cell 504 prior to receiving the cell activation indication 512 in the active cell 502. In some implementations, the UE 104 may receive the TCI state via an indication in a DCI message received in the deactivated cell 504.

For one or more of the configured deactivated cells indicated in the configuration 510, the UE 104 may be configured to determine whether a deactivated cell is configured with one or more PLRSs. For example, the UE 104 may check whether a configuration associated with the deactivated cell indicates any configuration for a PLRS, and if the associated configuration does not indicate any configurations for a PLRS, then the UE 104 may be configured to determine that the deactivated cell is not configured with a PLRS.

The UE 104 may be configured to measure one or more channel metrics of a QCL RS 520 received in the deactivated cell 504 based on determining that the deactivated cell 504 is not configured with a PLRS. The UE 104 may be configured to determine a transmission power measurement based on the measured channel metric of the QCL RS 520. The UE 104 may be configured to determine the transmission power measurement based on a power control algorithm, a power setting algorithm, and/or the like, and the one or more measured channel metrics of the QCL RS prior to receiving cell activation indication 512 in the active cell 502. In some implementations, the transmission power measurement for transmitting the uplink signal 516 may be determined prior to receiving the cell activation indication 512. In some implementations, the transmission power measurement for transmitting the uplink signal 516 in the currently deactivated candidate cell may be determined simultaneously with or after receiving the cell activation indication 512. In such a case, the power measurement would still be based on the QCL RS 520 received prior to the cell activation indication 512.

In some implementations, one or more PLRSs that a deactivated cell is configured with may be indicated in a configuration of an activated TCI state received in that deactivated cell. For example, referring to 500d of FIG. 5D, the deactivated cell 504 may be configured with one or more PLRSs, and the one or more PLRSs 522 may be indicated in a configuration of an activated TCI state. The UE 104 may be configured to monitor for and/or receive the one or more PLRSs 522 prior to receiving the cell activation indication 512. The UE 104 may be configured to measure one or more channel metrics of the one or more PLRSs 522, and determine the transmission power measurement for transmitting the uplink signal 516 based on the one or more measured channel metrics of the one or more PLRSs 522. In some implementations, the transmission power measurement for transmitting the uplink signal 516 may be determined prior to receiving the cell activation indication 512. In some implementations, the transmission power measurement for transmitting the uplink signal 516 in the currently deactivated candidate cell may be determined simultaneously with or after receiving the cell activation indication 512. In such a case, the power measurement would still be based on the set of PLRS 522 received prior to the cell activation indication 512

Referring to example 500e of FIG. 5E, in some implementations, if the UE 104 determines that a deactivated cell 504 is configured with a PLRS, the UE 104 may determine whether a configuration of an activated TCI state received in the deactivated cell 504 indicates a PLRS. If the UE 104 determines that the configuration does not include a PLRS, then the UE 104 may be configured to identify a default PLRS 526 indicated in a configuration 524 of an uplink bandwidth part (BWP) received in the deactivated cell.

The UE 104 may be configured to monitor for and/or receive one or more default PLRSs 526 in the deactivated cell 504 prior to receiving the cell activation indication 512. The UE 104 may be configured to measure one or more channel metrics of the one or more default PLRSs 526, and determine the transmission power measurement for transmitting the uplink signal 516 based on the one or more measured channel metrics of the one or more default PLRSs 526.

In some implementations, the UE 104 may be configured to determine transmission power measurement for transmitting the uplink signal 516 based on one or more default power control parameter values and/or the one or more measured channel metrics of the one or more configured PLRSs, the one or more default PLRSs, and/or the one or more QCL RS. In some implementations, a default power control parameter value may be a value indicated by a default close loop index (e.g., close loop index 0). In some implementations, a default power control parameter value may be a default P0 value, such as a P0 value indicated in an information element associated with uplink transmission (e.g., PUCCH power control, PUSCH power control, a SRS configuration, P0 value for a PRACH transmission, and/or the like) in the deactivated cell 504. In some implementations, such information element may be configured via RRC, DCI, and/or the like.

In some implementations, the UE 104 may be configured to determine transmission power measurement for transmitting the uplink signal 516 in the deactivated cell 504 based on one or more power control parameter values configured for transmission of the uplink signal 516 and/or the one or more measured channel metrics of the one or more configured PLRSs, the one or more default PLRSs, and/or the one or more QCL RS. In some implementations, a configured power control parameter value may be a value indicated by a close loop index configured for the transmission of the uplink signal 516 in the deactivated cell 504. In some implementations, the close loop index value may be indicated in a configuration of the TCI state (e.g., activated TCI state) received in the deactivated cell 504.

In some implementations, the UE 104 may be configured to transmit a capability indication to the network entity 102/180 indicating a maximum number of PLRSs that the UE 104 can support (e.g., maxNumberPathlossRS-update). In some implementations, the capability indication may indicate maximum number of PLRSs that the UE can support for PUSCH, PUCCH, SRS, and the like. In some implementations, the capability indication may indicate maximum number of SSB resources, CSI-RS resources, CSI-IM resources, and other similar resources that the UE can support.

In some implementations, the UE may determine the maximum number of PLRSs based on the total number of PLRSs that each of the deactivated cells indicated in the configuration 510 are configured with and the total number of PLRSs that each of the active cells are configured with. In some implementations, the UE may indicate the maximum number of PLRS as a combined value based on the total number of PLRSs that each of the deactivated cells indicated in the configuration 510 are configured with and the total number of PLRSs that each of the active cells are configured with.

In some implementations, the UE may indicate a maximum number of PLRS for the set of deactivated cells based on the total number of PLRSs that each of the deactivated cells indicated in the configuration 510 are configured with, and may indicate a maximum number of PLRS for the set of deactivated cells.

The above described techniques for determining transmission power measurements for transmitting uplink signal configure the UE 104 to determine the transmission power measurements in one or more deactivated cells prior to receiving a cell activation command from a network entity 102/180. Thus, the UE 104 may apply the determined power measurements and transmit an uplink signal immediately after receiving a cell activation indication activating the currently deactivated cell to a newly active cell, where the uplink signal is transmitted in the newly active cell. For example, the UE 104 is configured to transmit the uplink signal in a slot immediately following a slot in which it receives a cell activation indication or command activating the currently deactivated cell to a newly active cell, where the uplink signal is transmitted in the newly active cell.

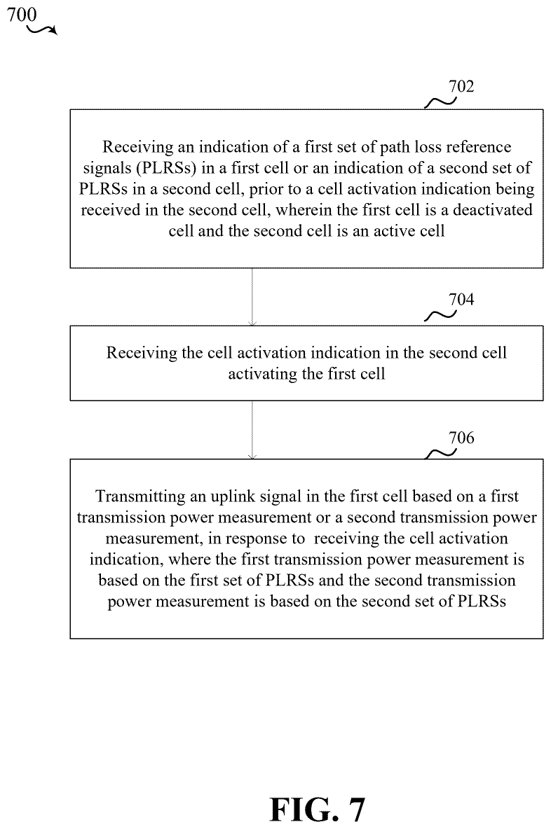

Referring to example 600 of FIG. 6 and FIG. 7, in operation, UE 104 may perform a method 700 of wireless communication, by such as via execution of UL power control component 198 by processor 605 and/or memory 360 (FIG. 3). In this case, the processor 605 may be the receive (rx) processor 356, the controller/processor 359, and/or the transmit (tx) processor 368 described above in FIG. 3.

At block 702, the method 700 includes receiving an indication of a first set of path loss reference signals (PLRSs) in a first cell or an indication of a second set of PLRSs in a second cell, prior to a cell activation indication being received in the second cell, wherein the first cell is a deactivated cell and the second cell is an active cell. For example, in an aspect, UE 104, processor 605, memory 360, UL power control component 198, and/or receiving component 620 may be configured to or may comprise means for receiving an indication of a first set of path loss reference signals (PLRSs) in a first cell or an indication of a second set of PLRSs in a second cell, prior to a cell activation indication being received in the second cell, wherein the first cell is a deactivated cell and the second cell is an active cell.

For example, the receiving at block 702 may include receiving the indication of a first set of path loss reference signals (PLRSs) in a first cell or the indication of a second set of PLRSs in a second cell via a wireless signal at an antenna or antenna array (e.g., antenna 352) as described in FIG. 3, and processing the received wireless signal and the indication of the first set of PLRSs or the indication of the second set of PLRSs as described above.

At block 704, the method 700 includes receiving the cell activation indication in the second cell activating the first cell. For example, in an aspect, UE 104, processor 605, memory 360, UL power control component 198, and/or receiving component 620 may be configured to or may comprise means for receiving the cell activation indication in the second cell activating the first cell.

For example, the receiving at block 702 may include receiving the cell activation indication via a wireless signal at an antenna or antenna array (e.g., antenna 352) as described in FIG. 3, and processing the received wireless signal and the cell activation indication as described above.

At block 706, the method 700 includes transmitting an uplink signal in the first cell based on a first transmission power measurement or a second transmission power measurement, in response to receiving the cell activation indication, where the first transmission power measurement is based on the first set of PLRSs and the second transmission power measurement is based on the second set of PLRSs. For example, in an aspect, UE 104, processor 605, memory 360, UL power control component 198, and/or transmitting component 625 may be configured to or may comprise means for transmitting an uplink signal in the first cell based on a first transmission power measurement or a second transmission power measurement, in response to receiving the cell activation indication, where the first transmission power measurement is based on the first set of PLRSs and the second transmission power measurement is based on the second set of PLRSs.

For example, the transmitting at block 706 may include transmitting the uplink signal via a wireless signal at an antenna or antenna array (e.g., antenna 352) as described in FIG. 3.

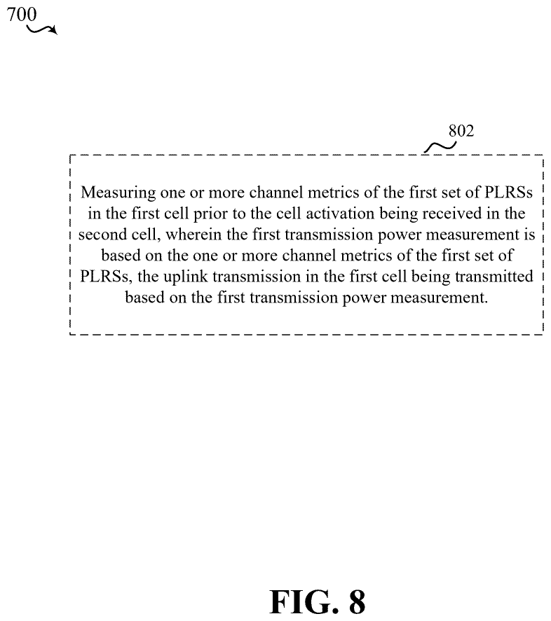

Referring to FIG. 8, in an alternative or additional aspect, at block 802, the method 700 may further include measuring one or more channel metrics of the first set of PLRSs in the first cell prior to the cell activation being received in the second cell, wherein the first transmission power measurement is based on the one or more channel metrics of the first set of PLRSs, the uplink transmission in the first cell being transmitted based on the first transmission power measurement. For example, in an aspect, UE 104, processor 605, memory 360, UL power control component 198, and/or measuring component 630 may be configured to or may comprise means for measuring one or more channel metrics of the first set of PLRSs in the first cell prior to the cell activation being received in the second cell, wherein the first transmission power measurement is based on the one or more channel metrics of the first set of PLRSs, the uplink transmission in the first cell being transmitted based on the first transmission power measurement.

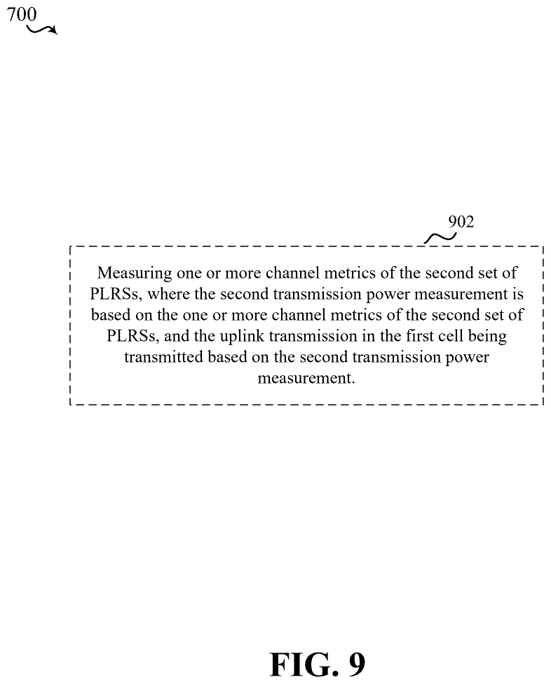

Referring to FIG. 9, in an alternative or additional aspect, at block 902, the method 700 may further include measuring one or more channel metrics of the second set of PLRSs, where the second transmission power measurement is based on the one or more channel metrics of the second set of PLRSs, and the uplink transmission in the first cell being transmitted based on the second transmission power measurement. For example, in an aspect, UE 104, processor 605, memory 360, UL power control component 198, and/or measuring component 630 may be configured to or may comprise means for measuring one or more channel metrics of the second set of PLRSs, where the second transmission power measurement is based on the one or more channel metrics of the second set of PLRSs, and the uplink transmission in the first cell being transmitted based on the second transmission power measurement.

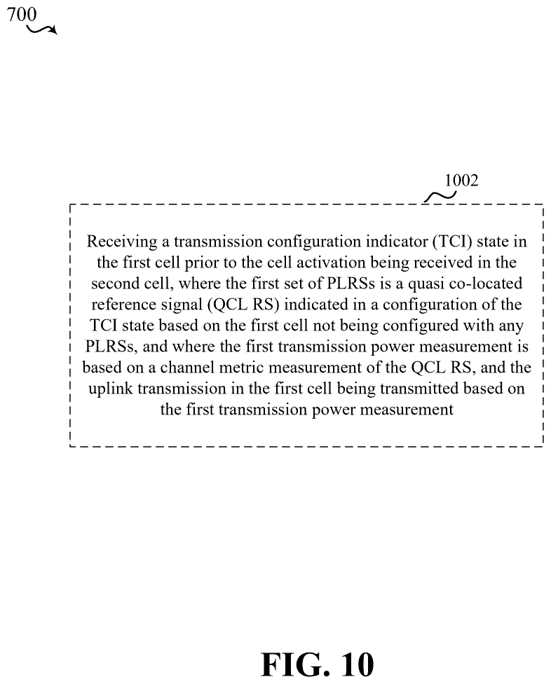

Referring to FIG. 10, in an alternative or additional aspect, at block 1002, the method 700 may further include receiving a transmission configuration indicator (TCI) state in the first cell prior to the cell activation being received in the second cell, where the first set of PLRSs is a quasi co-located reference signal (QCL RS) indicated in a configuration of the TCI state based on the first cell not being configured with any PLRSs, and where the first transmission power measurement is based on a channel metric measurement of the QCL RS, and the uplink transmission in the first cell being transmitted based on the first transmission power measurement. For example, in an aspect, UE 104, processor 605, memory 360, UL power control component 198, and/or receiving component 620 may be configured to or may comprise means for receiving a transmission configuration indicator (TCI) state in the first cell prior to the cell activation being received in the second cell, where the first set of PLRSs is a quasi co-located reference signal (QCL RS) indicated in a configuration of the TCI state based on the first cell not being configured with any PLRSs, and where the first transmission power measurement is based on a channel metric measurement of the QCL RS, and the uplink transmission in the first cell being transmitted based on the first transmission power measurement.

For example, the receiving at block 1002 may include receiving the TCI state via a wireless signal at an antenna or antenna array (e.g., antenna 352) as described in FIG. 3, and processing the received wireless signal and the received TCI state as described above.

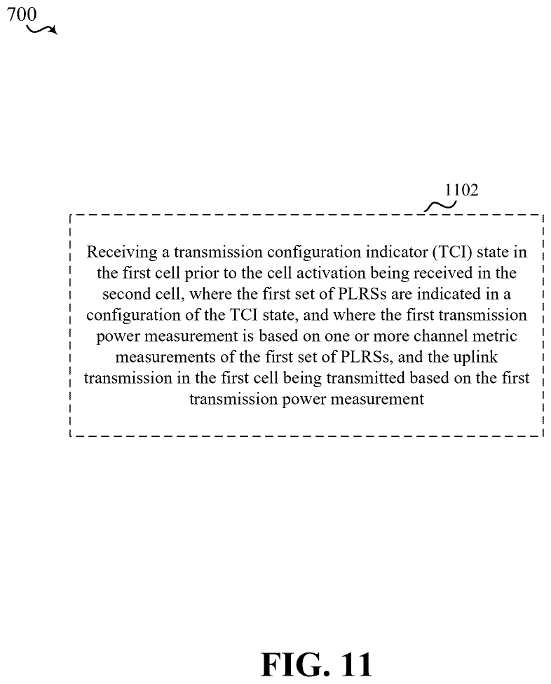

Referring to FIG. 11, in an alternative or additional aspect, at block 1102, the method 700 may further include receiving a transmission configuration indicator (TCI) state in the first cell prior to the cell activation being received in the second cell, where the first set of PLRSs are indicated in a configuration of the TCI state, and where the first transmission power measurement is based on one or more channel metric measurements of the first set of PLRSs, and the uplink transmission in the first cell being transmitted based on the first transmission power measurement. For example, in an aspect, UE 104, processor 605, memory 360, UL power control component 198, and/or receiving component 620 may be configured to or may comprise means for receiving a transmission configuration indicator (TCI) state in the first cell prior to the cell activation being received in the second cell, where the first set of PLRSs are indicated in a configuration of the TCI state, and where the first transmission power measurement is based on one or more channel metric measurements of the first set of PLRSs, and the uplink transmission in the first cell being transmitted based on the first transmission power measurement.

For example, the receiving at block 1102 may include receiving the TCI state via a wireless signal at an antenna or antenna array (e.g., antenna 352) as described in FIG. 3, and processing the received wireless signal and the received TCI state as described above.

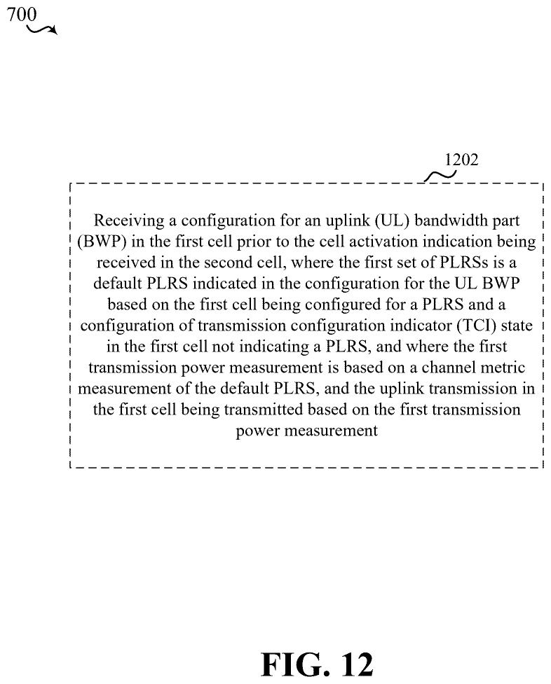

Referring to FIG. 12, in an alternative or additional aspect, at block 1202, the method 700 may further include receiving a configuration for an uplink (UL) bandwidth part (BWP) in the first cell prior to the cell activation indication being received in the second cell, where the first set of PLRSs is a default PLRS indicated in the configuration for the UL BWP based on the first cell being configured for a PLRS and a configuration of transmission configuration indicator (TCI) state in the first cell not indicating a PLRS, and where the first transmission power measurement is based on a channel metric measurement of the default PLRS, and the uplink transmission in the first cell being transmitted based on the first transmission power measurement. For example, in an aspect, UE 104, processor 605, memory 360, UL power control component 198, and/or receiving component 620 may be configured to or may comprise means for receiving a configuration for an uplink (UL) bandwidth part (BWP) in the first cell prior to the cell activation indication being received in the second cell, where the first set of PLRSs is a default PLRS indicated in the configuration for the UL BWP based on the first cell being configured for a PLRS and a configuration of transmission configuration indicator (TCI) state in the first cell not indicating a PLRS, and where the first transmission power measurement is based on a channel metric measurement of the default PLRS, and the uplink transmission in the first cell being transmitted based on the first transmission power measurement.

For example, the receiving at block 1202 may include receiving the configuration for the UL BWP via a wireless signal at an antenna or antenna array (e.g., antenna 352) as described in FIG. 3, and processing the received wireless signal and the received configuration as described above.

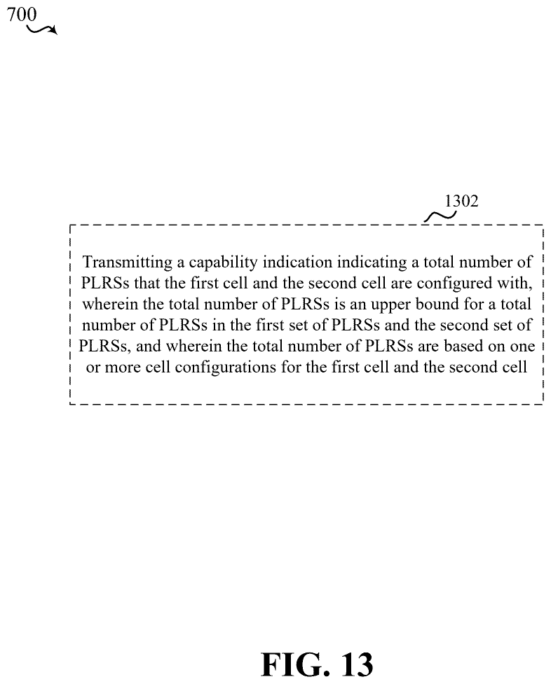

Referring to FIG. 13, in an alternative or additional aspect, at block 1302, the method 700 may further include transmitting a capability indication indicating a total number of PLRSs that the first cell and the second cell are configured with, wherein the indicated total number of PLRSs is an upper bound for a total number of PLRSs in the first set of PLRSs and the second set of PLRSs, and wherein the total number of PLRSs are based on one or more cell configurations for the first cell and the second cell. For example, in an aspect, UE 104, processor 605, memory 360, UL power control component 198, and/or transmitting component 625 may be configured to or may comprise means for transmitting a capability indication indicating a total number of PLRSs that the first cell and the second cell are configured with, wherein the indicated total number of PLRSs is an upper bound for a total number of PLRSs in the first set of PLRSs and the second set of PLRSs, and wherein the total number of PLRSs are based on one or more cell configurations for the first cell and the second cell.

For example, the transmitting at block 1302 may include transmitting the capability indication via a wireless signal at an antenna or antenna array (e.g., antenna 352) as described in FIG. 3.

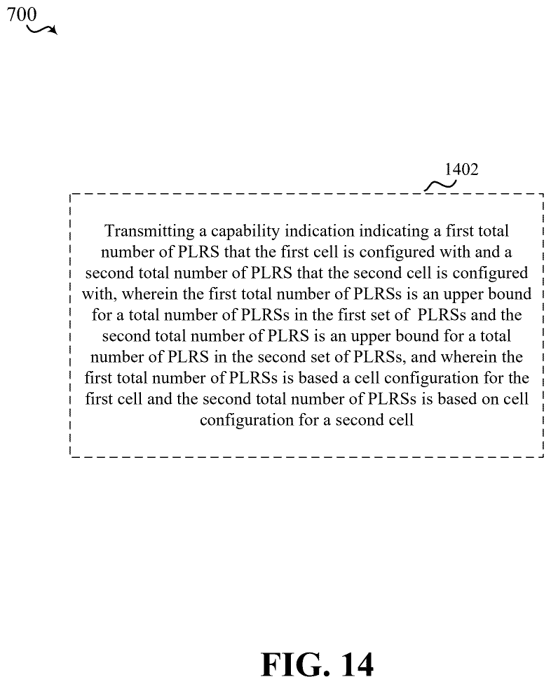

Referring to FIG. 14, in an alternative or additional aspect, at block 1402, the method 700 may further include transmitting a capability indication indicating a first total number of PLRS that the first cell is configured with and a second total number of PLRS that the second cell is configured with, wherein the indicated first total number of PLRSs is an upper bound for a total number of PLRSs in the first set of PLRSs and the second total number of PLRS is an upper bound for a total number of PLRS in the second set of PLRSs, and wherein the first total number of PLRSs is based a cell configuration for the first cell and the second total number of PLRSs is based on cell configuration for a second cell. For example, in an aspect, UE 104, processor 605, memory 360, UL power control component 198, and/or transmitting component 625 may be configured to or may comprise means for transmitting a capability indication indicating a first total number of PLRS that the first cell is configured with and a second total number of PLRS that the second cell is configured with, wherein the indicated first total number of PLRSs is an upper bound for a total number of PLRSs in the first set of PLRSs and the second total number of PLRS is an upper bound for a total number of PLRS in the second set of PLRSs, and wherein the first total number of PLRSs is based a cell configuration for the first cell and the second total number of PLRSs is based on cell configuration for a second cell.

For example, the transmitting at block 1402 may include transmitting the capability indication via a wireless signal at an antenna or antenna array (e.g., antenna 352) as described in FIG. 3.

In an alternative or additional aspect, the uplink transmission in the first cell is transmitted based on the first transmission power measurement, and the first transmission power measurement is further based on a default power control parameter value.

In an alternative or additional aspect, the default power control parameter value is a value indicated by default close loop index or a default target power control parameter value.

In an alternative or additional aspect, the default target power control parameter value is a default P0 value.

In an alternative or additional aspect, the uplink transmission in the first cell is transmitted based on the first transmission power measurement, and the first transmission power measurement is further based on a power control parameter value configured for the uplink transmission in the first cell.

In an alternative or additional aspect, the power control parameter value is indicated by a close loop index configured for the uplink transmission in the first cell and indicated in a configuration of a TCI state received in the first cell, prior to the cell activation indication being received in the second cell.

In an alternative or additional aspect, the power control parameter value is indicated by a target power control parameter value configured for the uplink transmission in the first cell and indicated in a configuration of a TCI state received in the first cell prior to the cell activation indication being received in the second cell.

In an alternative or additional aspect, the target power control parameter value is a P0 value configured for the uplink transmission.

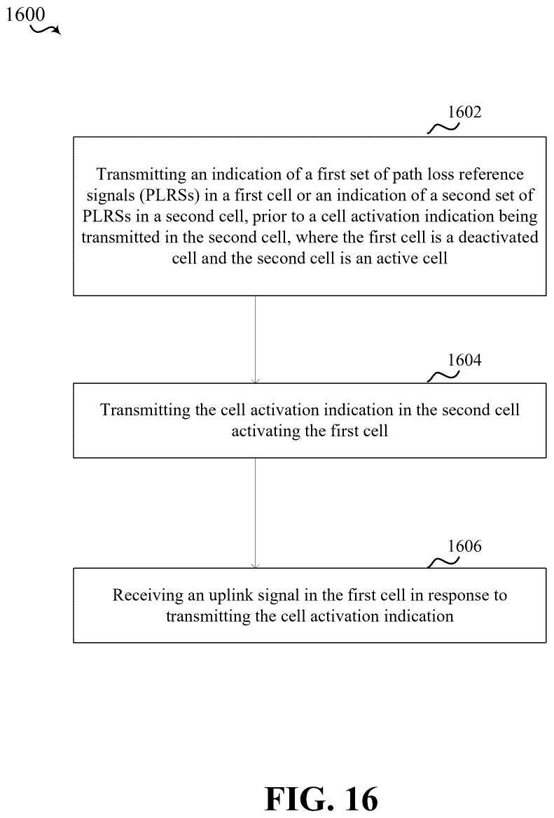

Referring to example 1500 of FIG. 15 and FIG. 16, in operation, network entity 102 may perform a method 1600 of wireless communication, by such as via execution of UL power control component 199 by processor 1506 and/or memory 376 (FIG. 3). In this case, the processor 1506 may be the receive (rx) processor 370, the controller/processor 375, and/or the transmit (tx) processor 316 described above in FIG. 3.

At block 1602, the method 1600 includes transmitting an indication of a first set of path loss reference signals (PLRSs) in a first cell or an indication of a second set of PLRSs in a second cell, prior to a cell activation indication being transmitted in the second cell, where the first cell is a deactivated cell and the second cell is an active cell. For example, in an aspect, network entity 102, processor 1506, memory 376, UL power control component 199, and/or transmitting component 1520 may be configured to or may comprise means for transmitting an indication of a first set of path loss reference signals (PLRSs) in a first cell or an indication of a second set of PLRSs in a second cell, prior to a cell activation indication being transmitted in the second cell, where the first cell is a deactivated cell and the second cell is an active cell.

For example, the transmitting at block 1602 may include transmitting the indication of the first set of PLRSs or the indication of the second set of PLRSs via one or more wireless signals transmitted using an antenna or an antenna array (e.g., antenna 320).

At block 1604, the method 1600 includes transmitting the cell activation indication in the second cell activating the first cell. For example, in an aspect, network entity 102, processor 1506, memory 376, UL power control component 199, and/or transmitting component 1520 may be configured to or may comprise means for transmitting the cell activation indication in the second cell activating the first cell.

For example, the transmitting at block 1604 may include transmitting the cell activation indication via one or more wireless signals transmitted using an antenna or an antenna array (e.g., antenna 320).

At block 1606, the method 1600 includes receiving an uplink signal in the first cell in response to transmitting the cell activation indication. For example, in an aspect, network entity 102, processor 1506, memory 376, UL power control component 199, and/or receiving component 1525 may be configured to or may comprise means for receiving the uplink signal in the first cell in response to transmitting the cell activation indication.

For example, the receiving at block 1606 may include receiving the uplink signal via a wireless signal at an antenna or antenna array (e.g., antenna 352) as described in FIG. 3, and processing the received wireless signal and the received uplink signal as described above.

In an alternative or additional aspect, the first set of PLRSs are transmitted in the first cell prior to the cell activation indication being transmitted in the second cell.

In an alternative or additional aspect, the second set of PLRSs are transmitted in second cell prior to the cell activation indication being transmitted in the second cell.

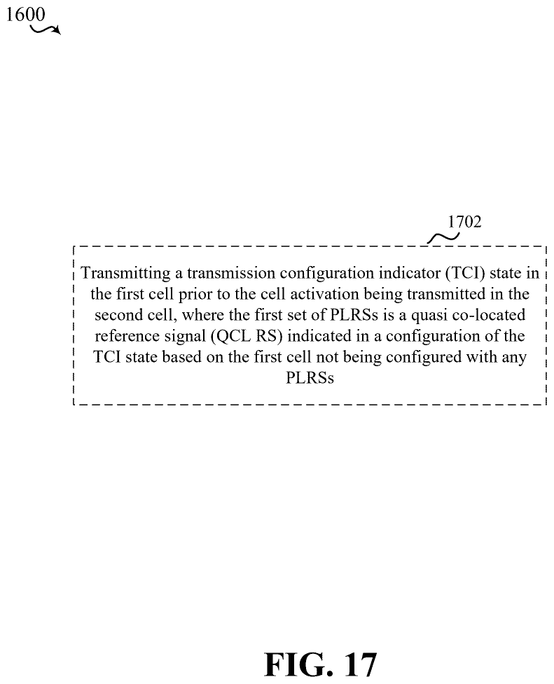

Referring to FIG. 17, in an alternative or additional aspect, at block 1702, the method 1600 may further include transmitting a transmission configuration indicator (TCI) state in the first cell prior to the cell activation being transmitted in the second cell, where the first set of PLRSs is a quasi co-located reference signal (QCL RS) indicated in a configuration of the TCI state based on the first cell not being configured with any PLRSs. For example, in an aspect, network entity 102, processor 1506, memory 376, UL power control component 199, and/or transmitting component 1520 may be configured to or may comprise means for transmitting a transmission configuration indicator (TCI) state in the first cell prior to the cell activation being transmitted in the second cell, where the first set of PLRSs is a quasi co-located reference signal (QCL RS) indicated in a configuration of the TCI state based on the first cell not being configured with any PLRSs.

For example, the transmitting at block 1702 may include transmitting the TCI state via one or more wireless signals transmitted using an antenna or an antenna array (e.g., antenna 320).

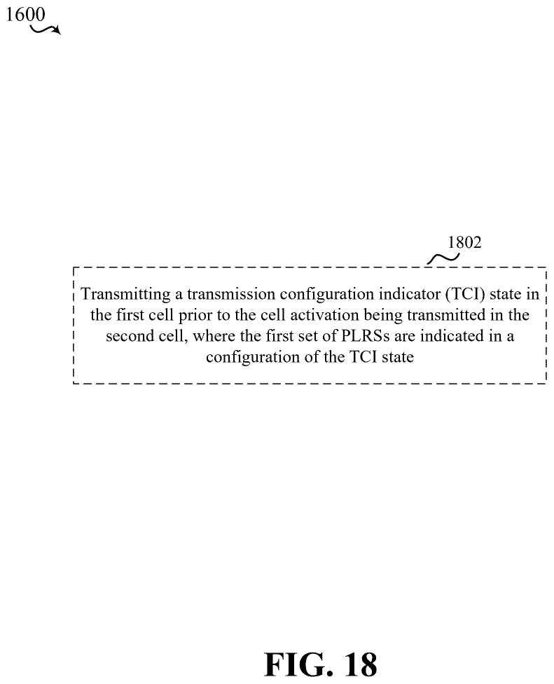

Referring to FIG. 18, in an alternative or additional aspect, at block 1802, the method 1600 may further include transmitting a transmission configuration indicator (TCI) state in the first cell prior to the cell activation being transmitted in the second cell, where the first set of PLRSs are indicated in a configuration of the TCI state. For example, in an aspect, network entity 102, processor 1506, memory 376, UL power control component 199, and/or transmitting component 1520 may be configured to or may comprise means for transmitting a transmission configuration indicator (TCI) state in the first cell prior to the cell activation being transmitted in the second cell, where the first set of PLRSs are indicated in a configuration of the TCI state.

For example, the transmitting at block 1802 may include transmitting the TCI state via one or more wireless signals transmitted using an antenna or an antenna array (e.g., antenna 320).

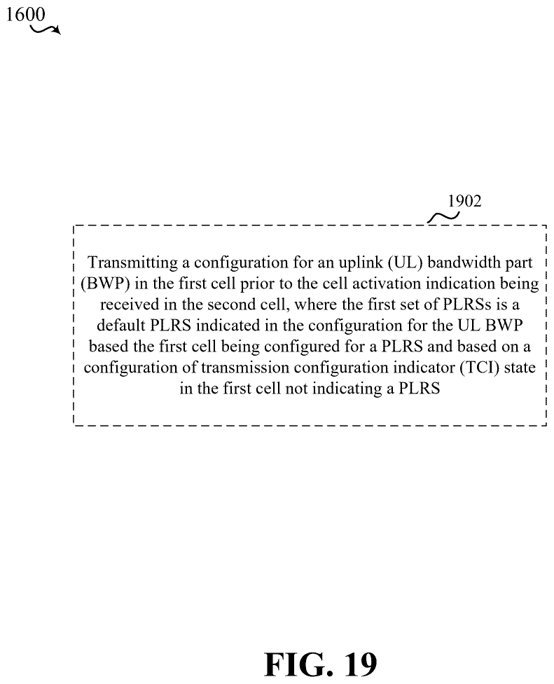

Referring to FIG. 19, in an alternative or additional aspect, at block 1902, the method 1600 may further include transmitting a configuration for an uplink (UL) bandwidth part (BWP) in the first cell prior to the cell activation indication being received in the second cell, where the first set of PLRSs is a default PLRS indicated in the configuration for the UL BWP based the first cell being configured for a PLRS and based on a configuration of transmission configuration indicator (TCI) state in the first cell not indicating a PLRS. For example, in an aspect, network entity 102, processor 1506, memory 376, UL power control component 199, and/or transmitting component 1520 may be configured to or may comprise means for transmitting a configuration for an uplink (UL) bandwidth part (BWP) in the first cell prior to the cell activation indication being received in the second cell, where the first set of PLRSs is a default PLRS indicated in the configuration for the UL BWP based the first cell being configured for a PLRS and based on a configuration of transmission configuration indicator (TCI) state in the first cell not indicating a PLRS.

For example, the transmitting at block 1902 may include transmitting the TCI state via one or more wireless signals transmitted using an antenna or an antenna array (e.g., antenna 320).

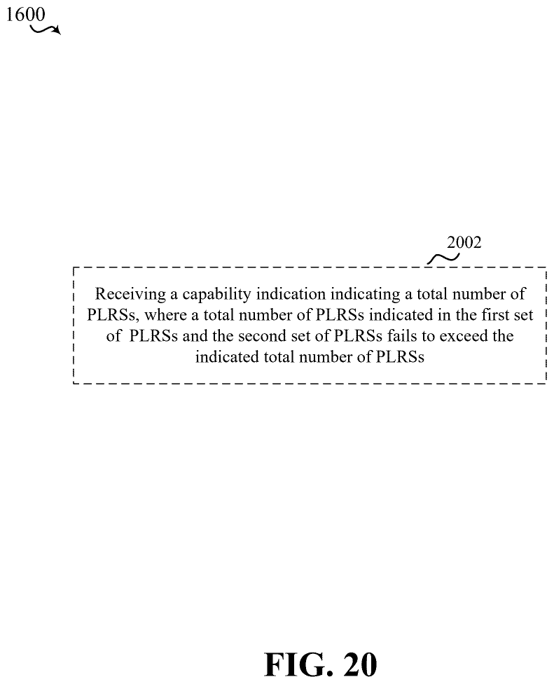

Referring to FIG. 20, in an alternative or additional aspect, at block 2002, the method 1600 may further include receiving a capability indication indicating a total number of PLRSs, where a total number of PLRSs indicated in the first set of PLRSs and the second set of PLRSs fails to exceed the indicated total number of PLRSs. For example, in an aspect, network entity 102, processor 1506, memory 376, UL power control component 199, and/or receiving component 1525 may be configured to or may comprise means for receiving a capability indication indicating a total number of PLRSs, where a total number of PLRSs indicated in the first set of PLRSs and the second set of PLRSs fails to exceed the indicated total number of PLRSs.

For example, the receiving at block 2002 may include receiving the capability indication via a wireless signal at an antenna or antenna array (e.g., antenna 352) as described in FIG. 3, and processing the received wireless signal and the capability indication as described above.

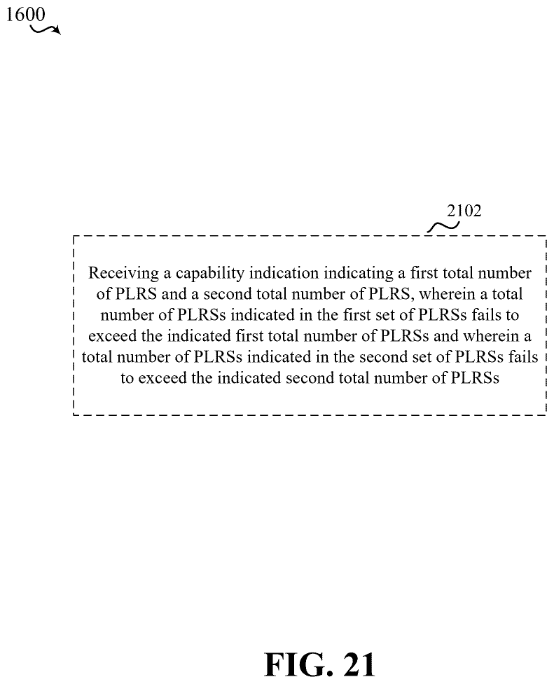

Referring to FIG. 21, in an alternative or additional aspect, at block 2102, the method 1600 may further include receiving a capability indication indicating a first total number of PLRS and a second total number of PLRS, wherein a total number of PLRSs indicated in the first set of PLRSs fails to exceed the indicated first total number of PLRSs and wherein a total number of PLRSs indicated in the second set of PLRSs fails to exceed the indicated second total number of PLRSs. For example, in an aspect, network entity 102, processor 1506, memory 376, UL power control component 199, and/or receiving component 1525 may be configured to or may comprise means for receiving a capability indication indicating a first total number of PLRS and a second total number of PLRS, wherein a total number of PLRSs indicated in the first set of PLRSs fails to exceed the indicated first total number of PLRSs and wherein a total number of PLRSs indicated in the second set of PLRSs fails to exceed the indicated second total number of PLRSs.

For example, the receiving at block 2102 may include receiving the capability indication via a wireless signal at an antenna or antenna array (e.g., antenna 352) as described in FIG. 3, and processing the received wireless signal and the capability indication as described above.

In an alternative or additional aspect, the cell activation indication is transmitted via a downlink control information (DCI) message.

In an alternative or additional aspect, a configuration of the first cell is transmitted via a radio resource control (RRC) message.

In an alternative or additional aspect, the indication of the first set of PLRSs is included in the configuration.

In an alternative or additional aspect, the configuration is transmitted prior to the cell activation indication being transmitted in the second cell.

In an alternative or additional aspect, the indication of the first set of PLRSs is not included in the configuration.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following examples are illustrative only and may be combined with aspects of other embodiments or teachings described herein, without limitation.

Example 1 is a method of wireless communication at a user equipment, comprising: receiving an indication of a first set of path loss reference signals (PLRSs) in a first cell or an indication of a second set of PLRSs in a second cell, prior to a cell activation indication being received in the second cell, wherein the first cell is a deactivated cell and the second cell is an active cell; receiving the cell activation indication in the second cell activating the first cell; and transmitting an uplink signal in the first cell based on a first transmission power measurement or a second transmission power measurement, in response to receiving the cell activation indication, where the first transmission power measurement is based on the first set of PLRSs and the second transmission power measurement is based on the second set of PLRSs.

Example 2 is the method of example 1, further comprising: measuring one or more channel metrics of the first set of PLRSs in the first cell prior to the cell activation being received in the second cell, wherein the first transmission power measurement is based on the one or more channel metrics of the first set of PLRSs, the uplink transmission in the first cell being transmitted based on the first transmission power measurement.

Example 3 is the method of example 1, further comprising: measuring one or more channel metrics of the second set of PLRSs, where the second transmission power measurement is based on the one or more channel metrics of the second set of PLRSs, and the uplink transmission in the first cell being transmitted based on the second transmission power measurement.

Example 4 is the method of example 1 further comprising: receiving a transmission configuration indicator (TCI) state in the first cell prior to the cell activation being received in the second cell, where the first set of PLRSs is a quasi co-located reference signal (QCL RS) indicated in a configuration of the TCI state based on the first cell not being configured with any PLRSs, and where the first transmission power measurement is based on a channel metric measurement of the QCL RS, and the uplink transmission in the first cell being transmitted based on the first transmission power measurement.

Example 5 is the method of example 1, further comprising: receiving a transmission configuration indicator (TCI) state in the first cell prior to the cell activation being received in the second cell, where the first set of PLRSs are indicated in a configuration of the TCI state, and where the first transmission power measurement is based on one or more channel metric measurements of the first set of PLRSs, and the uplink transmission in the first cell being transmitted based on the first transmission power measurement.

Example 6 is the method of example 1, further comprising: receiving a configuration for an uplink (UL) bandwidth part (BWP) in the first cell prior to the cell activation indication being received in the second cell, where the first set of PLRSs is a default PLRS indicated in the configuration for the UL BWP based on the first cell being configured for a PLRS and a configuration of transmission configuration indicator (TCI) state in the first cell not indicating a PLRS, and where the first transmission power measurement is based on a channel metric measurement of the default PLRS, and the uplink transmission in the first cell being transmitted based on the first transmission power measurement.

Example 7 is the method of example 1, further comprising: transmitting a capability indication indicating a total number of PLRSs that the first cell and the second cell are configured with, wherein the indicated total number of PLRSs is an upper bound for a total number of PLRSs in the first set of PLRSs and the second set of PLRSs, and wherein the total number of PLRSs are based on one or more cell configurations for the first cell and the second cell.

Example 8 is the method of example 1, further comprising: transmitting a capability indication indicating a first total number of PLRS that the first cell is configured with and a second total number of PLRS that the second cell is configured with, wherein the indicated first total number of PLRSs is an upper bound for a total number of PLRSs in the first set of PLRSs and the second total number of PLRS is an upper bound for a total number of PLRS in the second set of PLRSs, and wherein the first total number of PLRSs is based a cell configuration for the first cell and the second total number of PLRSs is based on cell configuration for a second cell.

Example 9 is the method of any of examples 1-8, wherein the uplink transmission in the first cell is transmitted based on the first transmission power measurement, and the first transmission power measurement is based on a default power control parameter value.

Example 10 is the method of example 9, wherein the default power control parameter value is a value indicated by default close loop index or a default target power control parameter value.

Example 11 is the method of example 10, wherein the default target power control parameter value is a default P0 value.

Example 12 is the method of any of examples 1-8, wherein the uplink transmission in the first cell is transmitted based on the first transmission power measurement, and the first transmission power measurement is based on a power control parameter value configured for the uplink transmission in the first cell.

Example 13 is the method of example 12, wherein the power control parameter value is indicated by a close loop index configured for the uplink transmission in the first cell and indicated in a configuration of a TCI state received in the first cell, prior to the cell activation indication being received in the second cell.

Example 14 is the method of example 12, wherein the power control parameter value is indicated by a target power control parameter value configured for the uplink transmission in the first cell and indicated in a configuration of a TCI state received in the first cell prior to the cell activation indication being received in the second cell.

Example 15 is the method example of 14, wherein the target power control parameter value is a P0 value configured for the uplink transmission.

Example 16 is a method of wireless communication at a network entity, comprising: transmitting an indication of a first set of path loss reference signals (PLRSs) in a first cell or an indication of a second set of PLRSs in a second cell, prior to a cell activation indication being transmitted in the second cell, where the first cell is a deactivated cell and the second cell is an active cell; transmitting the cell activation indication in the second cell activating the first cell; and receiving an uplink signal in the first cell in response to transmitting the cell activation indication.

Example 17 is the method of example 16, wherein the first set of PLRSs are transmitted in the first cell prior to the cell activation indication being transmitted in the second cell and the first transmission power measurement is based on one or more channel metrics of the first set of PLRSs.

Example 18 is the method of example 16, wherein the second set of PLRSs are transmitted in second cell prior to the cell activation indication being transmitted in the second cell.

Example 19 is the method of example 16 further comprising: transmitting a transmission configuration indicator (TCI) state in the first cell prior to the cell activation being transmitted in the second cell, where the first set of PLRSs is a quasi co-located reference signal (QCL RS) indicated in a configuration of the TCI state based on the first cell not being configured with any PLRSs.

Example 20 is the method of example 16 further comprising: transmitting a transmission configuration indicator (TCI) state in the first cell prior to the cell activation being transmitted in the second cell, where the first set of PLRSs are indicated in a configuration of the TCI state.

Example 21 is the method of example 16 further comprising: transmitting a configuration for an uplink (UL) bandwidth part (BWP) in the first cell prior to the cell activation indication being received in the second cell, where the first set of PLRSs is a default PLRS indicated in the configuration for the UL BWP based the first cell being configured for a PLRS and based on a configuration of transmission configuration indicator (TCI) state in the first cell not indicating a PLRS.

Example 22 is the method of example 16, further comprising: receiving a capability indication indicating a total number of PLRSs, where a total number of PLRSs indicated in the first set of PLRSs and the second set of PLRSs fails to exceed the indicated total number of PLRSs.

Example 23 is the method of example 16, further comprising: receiving a capability indication indicating a first total number of PLRS and a second total number of PLRS, wherein a total number of PLRSs indicated in the first set of PLRSs fails to exceed the indicated first total number of PLRSs and wherein a total number of PLRSs indicated in the second set of PLRSs fails to exceed the indicated second total number of PLRSs.

Example 24 is the method of any of examples 16-23, wherein the cell activation indication is transmitted via a downlink control information (DCI) message.

Example 25 is the method of any of examples 16-24, wherein a configuration of the first cell is transmitted via a radio resource control (RRC) message.

Example 26 is the method of example 25, wherein the indication of the first set of PLRSs is included in the configuration.

Example 27 is the method of example 25, wherein the configuration is transmitted prior to the cell activation indication being transmitted in the second cell.

Example 28 is the method of example 25, wherein the indication of the first set of PLRSs is not included in the configuration.

Example 29 is an apparatus for wireless communications, comprising means for performing a method in accordance with any one of examples 1-15.

Example 30 is an apparatus for wireless communications, comprising means for performing a method in accordance with any one of examples 16-28.

Example 31 is a non-transitory computer-readable medium comprising instructions that, when executed by an apparatus, causes the apparatus to perform a method in accordance with any one of examples 1-15.

Example 32 is a non-transitory computer-readable medium comprising instructions that, when executed by an apparatus, cause the apparatus to perform a method in accordance with any one of examples 16-28.

Example 33 is an apparatus for wireless communications, comprising: a memory comprising instructions; and one or more processors configured to execute the instructions to cause the apparatus to perform a method in accordance with any one of examples 1-15.

Example 34 is apparatus for wireless communications, comprising: a memory comprising instructions; and one or more processors configured to execute the instructions to cause the apparatus to perform a method in accordance with any one of examples 16-28.

What is claimed is:

1. An apparatus for wireless communication, comprising:
a processor;
memory coupled with the processor; and
instructions stored in the memory, when executed by the processor, cause the apparatus to:
receive an indication of a first set of path loss reference signals (PLRSs) in a first cell or an indication of a second set of PLRSs in a second cell, prior to a cell activation indication being received in the second cell, wherein the first cell is a deactivated cell and the second cell is an active cell;
receive the cell activation indication in the second cell activating the first cell; and
transmit an uplink signal in the first cell based on a first transmission power measurement or a second transmission power measurement, in response to receiving the cell activation indication, wherein the first transmission power measurement is based on the first set of PLRSs and the second transmission power measurement is based on the second set of PLRSs.

2. The apparatus of claim 1, wherein the instructions, when executed by the processor, further cause the apparatus to:
measure one or more channel metrics of the first set of PLRSs in the first cell prior to the cell activation indication being received in the second cell, wherein the first transmission power measurement is based on the one or more channel metrics of the first set of PLRSs,
the uplink signal in the first cell being transmitted based on the first transmission power measurement.

3. The apparatus of claim 1, wherein the instructions, when executed by the processor, further cause the apparatus to:
measure one or more channel metrics of the second set of PLRSs, wherein the second transmission power measurement is based on the one or more channel metrics of the second set of PLRSs,
the uplink signal in the first cell being transmitted based on the second transmission power measurement.

4. The apparatus of claim 1, wherein the instructions, when executed by the processor, further cause the apparatus to:
receive a transmission configuration indicator (TCI) state in the first cell prior to the cell activation indication being received in the second cell,
wherein the first set of PLRSs is a quasi co-located reference signal (QCL RS) indicated in a configuration of the TCI state based on the first cell not being configured with any PLRSs, and
wherein the first transmission power measurement is based on a channel metric measurement of the QCL RS, the uplink signal in the first cell being transmitted based on the first transmission power measurement.

5. The apparatus of claim 1, wherein the instructions, when executed by the processor, further cause the apparatus to:
receive a transmission configuration indicator (TCI) state in the first cell prior to the cell activation indication being received in the second cell,
wherein the first set of PLRSs are indicated in a configuration of the TCI state, and
wherein the first transmission power measurement is based on one or more channel metric measurements of the first set of PLRSs, the uplink signal in the first cell being transmitted based on the first transmission power measurement.

6. The apparatus of claim 1, wherein the instructions, when executed by the processor, further cause the apparatus to:
receive a configuration for an uplink (UL) bandwidth part (BWP) in the first cell prior to the cell activation indication being received in the second cell,
wherein the first set of PLRSs is a default PLRS indicated in the configuration for the UL BWP based on the first cell being configured for a PLRS and a configuration of transmission configuration indicator (TCI) state in the first cell not indicating a PLRS,
and wherein the first transmission power measurement is based on a channel metric measurement of the default PLRS, the uplink signal in the first cell being transmitted based on the first transmission power measurement.

7. The apparatus of claim 1, wherein the instructions, when executed by the processor, further cause the apparatus to:
transmit a capability indication indicating a total number of PLRSs that the first cell and the second cell are configured with, wherein the total number of PLRSs is an upper bound for a total number of PLRSs in the first set of PLRSs and the second set of PLRSs, and wherein the total number of PLRSs are based on one or more cell configurations for the first cell and the second cell.

8. The apparatus of claim 1, wherein the instructions, when executed by the processor, further cause the apparatus to:
transmit a capability indication indicating a first total number of PLRSs that the first cell is configured with and a second total number of PLRSs that the second cell is configured with, wherein the first total number of PLRSs is an upper bound for a total number of PLRSs in the first set of PLRSs and the second total number of PLRSs is an upper bound for a total number of PLRSs in the second set of PLRSs, and wherein the first total number of PLRSs is based a cell configuration for the first cell and the second total number of PLRSs is based on a cell configuration for the second cell.

9. The apparatus of claim 1, wherein the uplink signal in the first cell is transmitted based on the first transmission power measurement, and the first transmission power measurement is based on a default power control parameter value.

10. The apparatus of claim 9, wherein the default power control parameter value is a value indicated by default close loop index or a default target power control parameter value.

11. The apparatus of claim 10, wherein the default target power control parameter value is a default P0 value.

12. The apparatus of claim 1, wherein the uplink signal in the first cell is transmitted based on the first transmission power measurement, and the first transmission power measurement is based on a power control parameter value configured for the uplink signal in the first cell.

13. The apparatus of claim 12, wherein the power control parameter value is indicated by a close loop index configured for the uplink signal in the first cell and indicated in a configuration of a TCI state received in the first cell, prior to the cell activation indication being received in the second cell.

14. The apparatus of claim 12, wherein the power control parameter value is indicated by a target power control parameter value configured for the uplink signal in the first cell and indicated in a configuration of a TCI state received in the first cell prior to the cell activation indication being received in the second cell.

15. The apparatus of claim 14, wherein the target power control parameter value is a P0 value configured for the uplink signal.

16. An apparatus for wireless communication, comprising:
a processor;
memory coupled with the processor; and
instructions stored in the memory, when executed by the processor, to cause the apparatus to:
transmit an indication of a first set of path loss reference signals (PLRSs) in a first cell or an indication of a second set of PLRSs in a second cell, prior to a cell activation indication being transmitted in the second cell, wherein the first cell is a deactivated cell and the second cell is an active cell;
transmit the cell activation indication in the second cell activating the first cell; and
receive an uplink signal in the first cell in response to transmitting the cell activation indication.

17. The apparatus of claim 16, wherein the first set of PLRSs are transmitted in the first cell prior to the cell activation indication being transmitted in the second cell.

18. The apparatus of claim 16, wherein the second set of PLRSs are transmitted in the second cell prior to the cell activation indication being transmitted in the second cell.

19. The apparatus of claim 16, wherein the instructions, when executed by the processor, further cause the apparatus to:
transmit a transmission configuration indicator (TCI) state in the first cell prior to the cell activation indication being transmitted in the second cell,
wherein the first set of PLRSs is a quasi co-located reference signal (QCL RS) indicated in a configuration of the TCI state based on the first cell not being configured with any PLRSs.

20. The apparatus of claim 16, wherein the instructions, when executed by the processor, further cause the apparatus to:
transmit a transmission configuration indicator (TCI) state in the first cell prior to the cell activation indication being transmitted in the second cell,
wherein the first set of PLRSs are indicated in a configuration of the TCI state.

21. The apparatus of claim 16, wherein the instructions, when executed by the processor, further cause the apparatus to:
transmit a configuration for an uplink (UL) bandwidth part (BWP) in the first cell prior to the cell activation indication being transmitted in the second cell,
wherein the first set of PLRSs is a default PLRS indicated in the configuration for the UL BWP based the first cell being configured for a PLRS and based on a configuration of transmission configuration indicator (TCI) state in the first cell not indicating a PLRS.

22. The apparatus of claim 16, wherein the instructions, when executed by the processor, further cause the apparatus to:
receive a capability indication indicating a total number of PLRSs,
wherein a total number of PLRSs indicated in the first set of PLRSs and the second set of PLRSs fails to exceed the indicated total number of PLRSs.

23. The apparatus of claim 16, wherein the instructions, when executed by the processor, further cause the apparatus to:
receive a capability indication indicating a first total number of PLRSs and a second total number of PLRSs, wherein a total number of PLRSs indicated in the first set of PLRSs fails to exceed the indicated first total number of PLRSs and wherein a total number of PLRSs indicated in the second set of PLRSs fails to exceed the indicated second total number of PLRSs.

24. The apparatus of claim 16, wherein the cell activation indication is transmitted via a downlink control information (DCI) message.

25. The apparatus of claim 16, wherein a configuration of the first cell is transmitted via a radio resource control (RRC) message.

26. The apparatus of claim 25, wherein the indication of the first set of PLRSs is included in the configuration.

27. The apparatus of claim 25, wherein the configuration is transmitted prior to the cell activation indication being transmitted in the second cell.

28. The apparatus of claim 25, wherein the indication of the first set of PLRSs is not included in the configuration.

29. A method of wireless communication at a user equipment (UE), comprising:
receiving an indication of a first set of path loss reference signals (PLRSs) in a first cell or an indication of a second set of PLRSs in a second cell, prior to a cell activation indication being received in the second cell, wherein the first cell is a deactivated cell and the second cell is an active cell;
receiving the cell activation indication in the second cell activating the first cell; and
transmitting an uplink signal in the first cell based on a first transmission power measurement or a second transmission power measurement, in response to receiving the cell activation indication, wherein the first transmission power measurement is based on the first set of PLRSs and the second transmission power measurement is based on the second set of PLRSs.

30. A method of wireless communication at a network entity, comprising:
transmitting an indication of a first set of path loss reference signals (PLRSs) in a first cell or an indication of a second set of PLRSs in a second cell, prior to a cell activation indication being transmitted in the second cell, wherein the first cell is a deactivated cell and the second cell is an active cell;
transmitting the cell activation indication in the second cell activating the first cell; and
receiving an uplink signal in the first cell in response to transmitting the cell activation indication.
